(19) United States
(12) Patent Application Publication
(10) Pub. No.: US 2009/0249369 A1
(43) Pub. Date: Oct. 1, 2009

(54) MODULE-TO-MODULE ASSOCIATION SUPPORT METHOD, PROGRAM, AND SYSTEM

(76) Inventors: Akihiro ITOH, Kawasaki (JP); Yoshiyuki TAMUKAI, Yokohama (JP)

Correspondence Address: MATTINGLY & MALUR, P.C., 1800 DIAGONAL ROAD, SUITE 370, ALEXANDRIA, VA, 22314, US

(21) Appl. No.: 12/397,453

(22) Filed: Mar. 4, 2009

(30) Foreign Application Priority Data
Mar. 27, 2008 (JP) 2008-084989

(51) Int. Cl. G06F 9/46

(52) U.S. Cl. 719/328

(57) ABSTRACT

In a module-to-module association support system, a controller asks a management server to create an adaptor for use as an intermediary between a client module and a service module being a target to be associated with the client module. The management server is provided with a service API definition defining the specification of an API of the service module, and a device ID corresponding thereto. The management server selects the service API definition based on the device ID provided by the controller, and creates the adaptor based on the selected service API definition and the provided client API definition. The resulting adaptor is forwarded to a client. With such a configuration, a process to be executed after a change of the service module can be simplified to update an application including the client module.

### BACKGROUND OF THE INVENTION

The present invention relates to a technology for improving the flexibility of module-to-module association in computer software and, more specifically, to a technology for automating interface conversion.

For development of software systems, a group of mutually-independent software components is often developed first as a module, and the resulting module is made associated with others so that the entire system is constructed. For implementing such module-to-module association, generally, a module to be used by other modules, i.e., service module, makes public an interface to allow the use of its own capabilities, and the remaining modules using the service module, i.e., client modules, accordingly use the interface of the service module. Such an interface for use by the service module is determined prior to development of the modules, thereby being able to pursue the development work of the modules in isolation from other works.

When the service module has various capabilities, a general-purpose interface is used therefor to cover such various capabilities. When an interface expected by a client module for a service module is not the same as the actual interface therefor, an adaptor is known to be used as an intermediary between the service module and the client module. The adaptor operates as a service module with respect to a client module, and operates as a client module with respect to a service module.

Patent Document 1 (JP-A-2002-132739) describes a technology for downloading, from a server to a plurality of clients, any stub suited to the running environment varying among the clients at the time of execution of an application. The stub is the one to be ready on the server side for each of the clients when the clients use any same RMI (Remote Method Invocation) service. This technology enables to save the work trouble of installing different stabs to suit the clients.

Patent Document 2 (JP-A-2006-244009) describes a technology for creating a package file of a driver from a core module of the driver and a sub module whatever selected, and forwarding the resulting file to a client device. That is, a server is provided in advance thereon with a core module of a driver for running on a client device and sub modules. When receiving a request from the client device for downloading a package file of the driver, the server selects any of the sub modules in accordance with the client device for use to create the package file together with the core module of the driver. The core module is not dependent on the environment of the client device, but the sub modules are dependent thereon. This thus enables to provide each of the client devices with a driver matching thereto even if the client devices are in their own environment.

Patent Document 3 (JP-A-2002-014821) describes a technology for transmitting an application execution object to a client. The execution object is the one to be created with reference to a link information table based on the type of a platform added to a download request coming from a client. The server is provided in advance thereon with a group of modules for running by the client. This thus enables to customize and distribute the execution objects to suit different platforms of the clients. The problem here is that, however, the technologies of Patent Documents 1 to 3 are alike with the previous development technique for computer software as are using the interfaces previously provided, i.e., the interface of the RMI service in Patent Document 1, the interface between the core module and the sub modules in Patent Document 2, and the interface between the modules in Patent Document 3.

### SUMMARY OF THE INVENTION

The previous development technique for computer software requires to, every time the interface of a service module is updated, update of client modules and adaptors using the service module. Some measures may be taken as designing in advance the interface of the service module in anticipation of the extension of capabilities, but such measures may not be enough if any unexpected capabilities are to be added.

For development of systems using sensors, for example, any module in charge of controlling the sensors, i.e., sensor control module, may be made available for use by an application. However, because the interface for such a sensor control module is not yet standardized in the industry, every time any new sensor is installed, the application is thus required to be updated. Such a replacement of component including the sensor for use is made very often especially at the development stage of the system because repeated trial and error is expected for selection of the component. A component replacement leads to the need for adjustment of client modules and adaptors because the interface has to be also replaced with another for accessing the new component.

Even if an adaptor is created for allowing shared use of an interface among a plurality of sensor control modules, there still needs to replace the interface provided by the adaptor if a sensor to be newly installed is with any unexpected capabilities. Such a replacement of interface leads to the need for updating the application.

When the interface of the service module is changed as such, for every replacement of an interface, previously, engineers had to go through a very troublesome procedure, i.e., had to understand the specification of the interface of the service module by reading the specification form of components such as sensor, and once understood, they had to create manually an interface of a client module so as to correspond to the interface of the service module.

Such problems are also observed with system construction by SOA (Service-Oriented Architecture). The SOA is the system architecture for constructing a flexible enterprise system through association among software components made public on the network. The software components are those created in consideration of the configuration unit of a business process. With this architecture, when some change is made to a certain business process, this causes the need for updating not only the interface of a service module providing the capabilities of the business process but also every client module using the service module. That is, there needs to update also the client module having no direct relation to the change made to the business process, thereby placing the enormous burden on the engineers in charge of system development.

With the technology of Patent Document 1, when some change is made to the interface for the RMI service for extension of capabilities of the RMI service, for example, this results in the need for updating every client program using the interface, thereby causing the problem similar to the above.

The technology of Patent Document 2 indeed describes the way to provide, with ease, a device driver suited to a client device, but gives no consideration at all about what to do with a replacement of component to be coupled to the client device. As a result, when a component coupled to the client device is replaced with another, to suite the component after the replacement, there needs to create again a driver core module being the basis of the device driver, thereby causing the problem similar to the above. Moreover, when the driver core module is increased in number and/or size, module creation will become difficult to a further degree. Changing the interface between the driver core module and the sub modules will cause the need for updating not only the driver core module but also every sub module using the interface.

Similarly, the technology of Patent Document 3 indeed describes the way to create an application execution object on the side of a server to suit the platform of a client, but gives no consideration at all about what to do with a change of application provided by the server. This thus causes the need for creating again a group of modules configuring the application every time the provided application is changed, thereby leading to the problem similar to the above. Moreover, when the application is increased in number and/or size, module creation will become difficult to a further degree. Changing the interface of a certain module will cause the need for updating every module dependent on the certain module.

In consideration of above problems, an object of the invention is to simplify a process to be executed after a change of a service module to update an application including a client module.

In order to achieve the object, a first aspect of the invention is directed to a module-to-module association support method that supports, as an intermediary, a relation between a service module providing its own capabilities to other modules, and a client module using the capabilities of the service module. The method includes: a service API (Application Program Interface) definition step of storing, with a correlation, service API definition information with which a specification of an API of the service module is defined, and semantic information about the service module; a client API definition step of storing, with a correlation, client API definition information with which a specification of an API of the client module is defined, and semantic information about the client module; a step of selecting any of the client module and others; a step of acquiring client module semantic information about the selected client module, determining service module semantic information matching the acquired client module semantic information, and selecting the service module corresponding to the determined service module semantic information as a target to associate with the selected client module; and a step of creating, based on the client API definition information about the selected client module and the service API definition information about the selected service module, an adaptor for use as an intermediary between the selected client module and the selected service module.

In the first aspect, the service API definition step includes a step of storing, with a correlation, as the service API definition information, a service API function for use by the API of the service module and semantic information about the service API function, the client API definition step includes a step of storing, with a correlation, as the client API definition information, a client API function for use by the API of the client module and semantic information about the client API function. The step of creating the adaptor includes: when either a term of client or a term of service is referred to as “first”, and a remaining is referred to as “second”, a step of selecting the first API function for use by the API of the selected first module; a step of acquiring first API function semantic information about the selected first API function, determining second API function semantic information matching the acquired first API function semantic information, and selecting the second API function corresponding to the determined second API function semantic information for use by the selected second module as a target to associate with the selected first API function; and a step of creating, based on the selected first API function and the selected second API function, a part of the adaptor for use as the intermediary between the selected first API function and the selected second API function.

Also in the first aspect, the service API definition step includes a step of storing, with a correlation, as the service API definition information, parameters of the service API function for use by the API of the service module and semantic information about the parameters, the client API definition step includes a step of storing, with a correlation, as the client API definition information, parameters of the client API function for use by the API of the client module and semantic information about the parameters. The step of creating the part of the adaptor includes: a step of selecting any of the parameters of the selected first API function; a step of acquiring first API function parameter semantic information about the selected parameter of the first API function, determining second API function parameter semantic information matching the acquired first API function parameter semantic information, and selecting any of the parameters of the selected second API function corresponding to the determined second API function parameter semantic information as a target to associate with the selected parameter of the first API function; and a step of creating, with a correlation between the selected parameter of the first API function and the selected parameter of the second API function, the part of the adaptor for use as the intermediary between the selected first API function and the selected second API function.

Also in the first aspect, the client API definition step includes a step of storing, with a correlation, as the client API definition information, fixed values and semantic information about the fixed values. The step of creating the part of the adaptor includes: a step of identifying, when the selected first API function is the service API function, any of the parameters of the service API function whose semantic information is fixed value semantic information; a step of selecting any of the fixed values corresponding to the semantic information matching the fixed value semantic information of the identified parameter of the service API function as a target to associate with the identified parameter of the service API function; and a step of correlating the selected parameter of the client API function and the selected parameter of the service API function, substituting the selected fixed value into the specified parameter of the service API function, and creating the part of the adaptor for use as the intermediary between the selected client API function and the selected service API function.

Also in the first aspect, a step is further provided for linking the created adaptor to the selected client module.

Also in the first aspect, the service module serves to perform data acquisition utilizing an external unit, and the external unit includes a program unit operating in an electronic device such as sensor or in a computer on a network.

Also in the first aspect, in the step of creating the adaptor, the adaptor is created in such a manner as to acquire information for use to access the external unit at the time of running of the adaptor.

A module-to-module association support program of the invention characteristically implements the method of the first aspect in a computer.

A second aspect of the invention is directed to a module-to-module association support system that supports, as an intermediary, a relation between a service module providing its own capabilities to other modules, and a client module using the capabilities of the service module. The system includes: a service API definition storage section that stores, with a correlation, service API definition information with which a specification of an API of the service module is defined, and semantic information about the service module; a client API definition storage section that stores, with a correlation, client API definition information with which a specification of an API of the client module is defined, and semantic information about the client module; an adaptor creation request section that makes a selection from the client module and others; an association target selection section that acquires client module semantic information about the selected client module, determines service module semantic information matching the acquired client module semantic information, and selects the service module corresponding to the determined service module semantic information as a target to associate with the selected client module; and an adaptor creation section that creates, based on the client API definition information about the selected client module and the service API definition information about the selected service module, an adaptor for use as an intermediary between the selected client module and the selected service module.

In the second aspect, the service API definition storage section stores, with a correlation, as the service API definition information, a service API function for use by the API of the service module and semantic information about the service API function, and the client API definition storage section stores, with a correlation, as the client API definition information, a client API function for use by the API of the client module and semantic information about the client API function, and the adaptor creation section, when either a term of client or a term of service is referred to as “first”, and a remaining is referred to as “second”, selects the first API function for use by the API of the selected first module, acquires first API function semantic information corresponding to the selected first API function, determines second API function semantic information matching the acquired first API function semantic information, selects the second API function corresponding to the determined second API function semantic information for use by the selected second module as a target to associate with the selected first API function, and creates, based on the selected first API function and the selected second API function, a part of the adaptor for use as the intermediary between the selected first API function and the selected second API function.

Also in the second aspect, the service API definition storage section stores, with a correlation, as the service API definition information, parameters of the service API function for use by the API of the service module and semantic information about the parameters, the client API definition storage section stores, with a correlation, as the client API definition information, parameters of the client API function for use by the API of the client module and semantic information about the parameters, and the adaptor creation section selects any of the parameters of the selected first API function, acquires first API function parameter semantic information about the selected parameter of the first API function, determines second API function parameter semantic information matching the acquired first API function parameter semantic information, and selects any of the parameters of the selected second API function corresponding to the determined second API function parameter semantic information as a target to associate with the selected parameter of the first API function, and creates, with a correlation between the selected parameter of the first API function and the selected parameter of the second API function, the part of the adaptor for use as the intermediary between the selected first API function and the selected second API function.

Also in the second aspect, the client API definition storage section stores, with a correlation, as the client API definition information, fixed values and semantic information about the fixed values, and the adaptor creation section identifies, when the selected first API function is the service API function, any of the parameters of the service API function whose semantic information is fixed value semantic information, selects any of the fixed values corresponding to the semantic information matching the fixed value semantic information of the identified parameter of the service API function as a target to associate with the identified parameter of the service API function, and correlates the selected parameter of the client API function and the selected parameter of the service API function, substitutes the selected fixed value into the specified parameter of the service API function, and creates the part of the adaptor for use as the intermediary between the selected client API function and the selected service API function.

Also in the second aspect, the adaptor creation request section links the created adaptor to the selected client module.

Also in the second aspect, the service module serves to perform data acquisition utilizing an external unit, and the external unit includes a program unit operating in an electronic device such as sensor or in a computer on a network.

Also in the second aspect, the adaptor creation section creates the adaptor in such a manner as to acquire information for use to access the external unit at the time of running of the adaptor.

According to the first and second aspects of the invention, an adaptor for use to associate modules with each other is automatically created based on a service API definition and a client API definition. This favorably eliminates the need for a change of application including a client module even with a replacement of the interface of a service module, thereby implementing flexible association between the modules.

What is more, mapping of arguments and return values is performed based on semantic information provided to the service API definition and the client API definition, thereby being able to appropriately associate the modules with each other even if the arguments and the return values vary by type and configuration, e.g., value and array.

These and other features, objects and advantages of the present invention will become more apparent from the following description when taken in conjunction with the accompanying drawings wherein:

### BRIEF DESCRIPTION OF THE DRAWINGS

FIG. 1 is a diagram showing the system configuration in a first example;

FIG. 2 is a diagram showing the hardware configuration implementing the capabilities of a computer in an embodiment of the invention;

FIG. 3 is a flowchart of a procedure for creating an adaptor, and incorporating the resulting adaptor into a controller in the first example;

FIG. 4 is a diagram showing an exemplary interface of a service API in the first example;

FIG. 5 is a diagram showing an exemplary interface of a client API in the first example;

FIG. 6 is a diagram showing exemplary device definition information in the first example;

FIG. 7 is a diagram showing exemplary configuration information in the first example;

FIG. 8 is a diagram showing description rules of a client API definition and those of a service API definition;

FIG. 9 is a flowchart of a detailed procedure for creating an adaptor code in the first example;

FIGS. 10A and 10B are each a diagram showing an exemplary parameter tree of the client API in the first example;

FIGS. 11A and 11B are each a diagram showing an exemplary parameter tree of the service API in the first example;

FIGS. 12A and 12B are each a diagram showing an exemplary parameter map table in the first example;

FIG. 13 is a flowchart of a procedure for parameter mapping in the first example;

FIG. 14 is a flowchart of a detailed procedure for creating a source code in the first example;

FIG. 15 is a flowchart of a detailed procedure for creating a variable-transformation source code in the first example;

FIG. 16 is a diagram showing an exemplary source code of an automatically-created adaptor in the first example;

FIG. 17 is a diagram showing another exemplary source code of an automatically-created adaptor in the first example;

FIG. 18 is a diagram showing the system configuration in a second example;

FIG. 19 is a flowchart of a procedure for creating an adaptor, and incorporating the resulting adaptor into a controller in the second example; and

FIG. 20 is a diagram showing the system configuration in a third example.

### DESCRIPTION OF THE EMBODIMENTS

### FIRST EXAMPLE

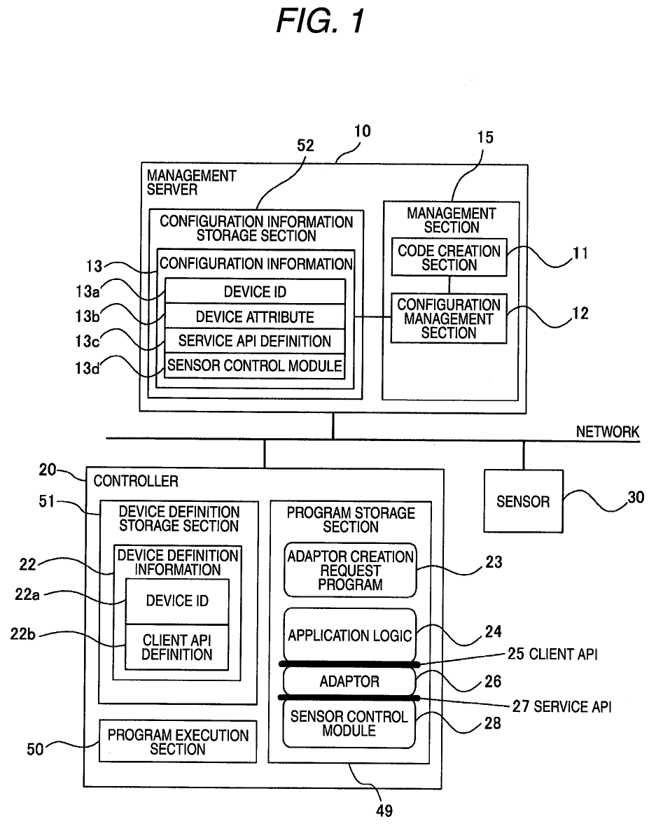

FIG. 1 shows the system configuration in a first example. In this example, described is a sensor control system as an example of a module-to-module association support system that supports, as an intermediary, the relation between a service module and a client module. The service module is the one providing its own capabilities to other modules, and the client module is the one using the capabilities of the service module.

In this system, a network couples together a management server 10, a controller 20, and a sensor 30 so that these components can communicate with one another.

For the sake of simplicity, FIG. 1 shows one each of the components, i.e., the sensor 30, the controller 20, and a program execution section 50. In the actual system, a plurality of sensors 30 varying by type are controlled by a plurality of controllers 20, and at the same time, a plurality of program execution sections 50 operate. Such a system is applicable to various types of devices, e.g., air conditioning control system for indoor use.

In this example, the sensor 30 is coupled to the network, but this is surely not the only option for the communications means between the sensor 30 and the controller 20. For example, the sensor 30 and the controller 20 may be directly coupled together by a cable such as RS-232C, or wireless communications means such as infrared communications may be used. The sensor 30 is not restricted by type for use, and may be a temperature sensor, a humidity sensor, a human detection sensor, and an RFID (radio frequency identification) R/W. Choosing what type of sensor to use is dependent on the purpose of use of the sensor 30 by the program execution section 50, and has no direction relation to the object of the invention.

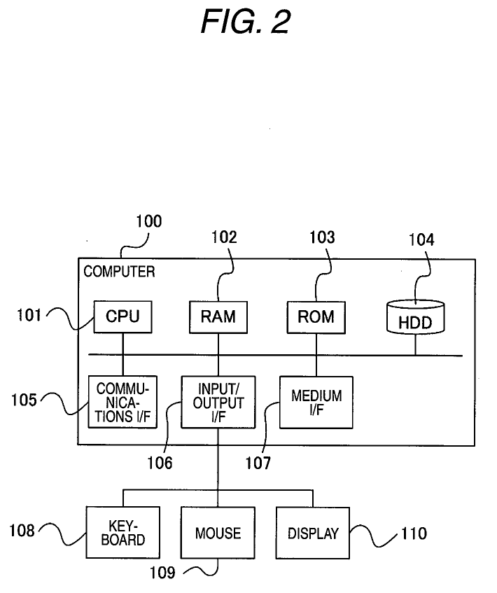

The management server 10 and the controller 20 can each be a computer 100 of a general configuration as shown in FIG. 2, i.e., an internal coupling is established among a CPU (Central Processing Unit) 101, a RAM (Random-Access Memory) 102, a ROM (Read-Only Memory) 103, a secondary storage device 104 such as HDD (Hard Disk Drive), a communications I/F (Interface) 105, an input/output I/F 106, and a medium I/F 107, and these components operate while cooperating with one another. The communications I/F 105 is provided for communications over the network, the input/output I/F 106 is for data input/output with a user, and the medium I/F 107 is for accessing an external medium such as CD-ROM (Compact Disc Read-Only Memory) and DVD (Digital Versatile Disc). The computer 100 is typically put in use with a coupling between the input/output I/F 106 and input and output devices such as a keyboard 108, a mouse 109, and a display 110.

The controller 20 is configured to include a program storage section 49, the program execution section 50, and a device definition storage section 51. The program storage section 49 serves to store therein various types of programs, and the program execution section 50 is to be implemented in capability terms by the CPU 101 running the various types of programs stored in the program storage section 49. The device definition storage section 51 serves as a client API (Application Program Interface) definition storage section.

The program storage section 49 stores therein an adaptor creation request program 23, an application logic 24 serving as a client module, a sensor control module 28 serving as a service module, and an adaptor 26 for use as an intermediary between the application logic 24 and the sensor control module 28. The application logic 24 includes a client API 25 as an API, and the sensor control module 28 includes a service API 27 as an API. Note here that the program storage section 49 is implemented using storage means such as the RAM 102 and the HDD 104.

Herein, the term API denotes a rule for making public the capabilities of a program by calling those from any other program for use. The general API is in the form of a function (including a group of functions), and for calling the function(s) of an API from an application, a parameter (argument) is designated as appropriate therefor.

The adaptor creation request program 23 is run to ask the management server 10 to create the adaptor 26 and forward the resulting adaptor thereto, and to link (dynamically or statically) the provided adaptor 26 to the application logic 24 and the sensor control module 28. The program execution section 50 to be implemented by the CPU 101 of the controller 20 running the adaptor creation request program 23 serves also as an adaptor creation request section, i.e., selects the application logic 24 for control of the sensor 30, and asks the management server 10 to create the adaptor 26 together with a device ID 22a, which serves as semantic information about the application logic 24, i.e., client module semantic information.

In this example, the semantic information is about the meaning of the application logic 24, and about the meaning of the sensor control module 28, for example. The former semantic information is referred to as client module semantic information, and the latter as service module semantic information. More in detail, such semantic information includes various information for use to identify the sensor 30 being an external unit, e.g., device ID, device name, measurement item, position information, and manufacture name. Herein, the position information includes various information for helping to identify the placement position of the external unit, e.g., IP (Internet Protocol) address, port number, room number, and floor number.

Such semantic information can be also provided to a client API function for use by the API of the application logic 24, and a service API function for use by the API of the sensor control module 28. Such semantic information, i.e., client API function semantic information and service API function semantic information, includes information about the meaning of the function, e.g., information about the use and details of the function such as “asynchronous reading through device control (devCntl/asyncRead), information about the function name, and information about the function type.

The semantic information can be also provided to a parameter of the client API function, and to a parameter of the service API function. Such semantic information, i.e., client API function parameter semantic information and service API function parameter semantic information, includes information about the meaning of the parameter, e.g., information about the use and details of the parameter such as “time interval for device control (devCntl/interval) and “password for device access (devCntl/password), information about the variable name, information about the type, information about the ID for parameter identification, and information about which of input and output is applicable. In this example, the parameter includes a parameter fixed in value, i.e., fixed value, and the semantic information about such a fixed value is referred to as fixed value semantic information.

The application logic 24 is a program serving as a client module, indicating the specific details of an application, e.g. measurement value collection of the sensor 30.

The adaptor 26 is a program to serve as an intermediary between the application logic 24 and the sensor control module 28.

The sensor control module 28 is a program serving as a service module, acquiring data using an external unit. The sensor control module 28 provides the capabilities for controlling the sensor 30 to the application logic 24, for example.

The program execution section 50 to be implemented in capability terms by the CPU 101 of the controller 20 running the application logic 24, the adaptor 26, and the sensor control module 28 controls the sensor 30, and uses and makes the most of the data collected from the sensor. For process implementation by the program execution section 50, the application logic 24 and the sensor control module 28 are needed to be associated with each other to allow exchange of arguments and return values of parameters of a function(s).

In this example, instead of using the service API 27 directly from the application logic 24, the service API 27 is used from the application logic 24 via the adaptor 26. That is, the sensor control module 28 is used by calling the client API 25 as an interface provided by the adaptor 26 for use of sensor control, and then by calling the service API 27 of the sensor control module 28 via the adaptor 26.

The device definition storage section 51 stores therein device definition information 22, which is about a correlation between a client API definition 22b and semantic information about the application logic 24. The client API definition 22b is the one defining the specification of the client API 25 of the application logic 24. To be specific, in this example, for the semantic information about the application logic 24, the device ID 22a is used for identifying the sensor 30 under the control of the program execution section 50. Note here that the device definition storage section 51 is to be implemented by using storage means such as the RAM 102 and the HDD 104.

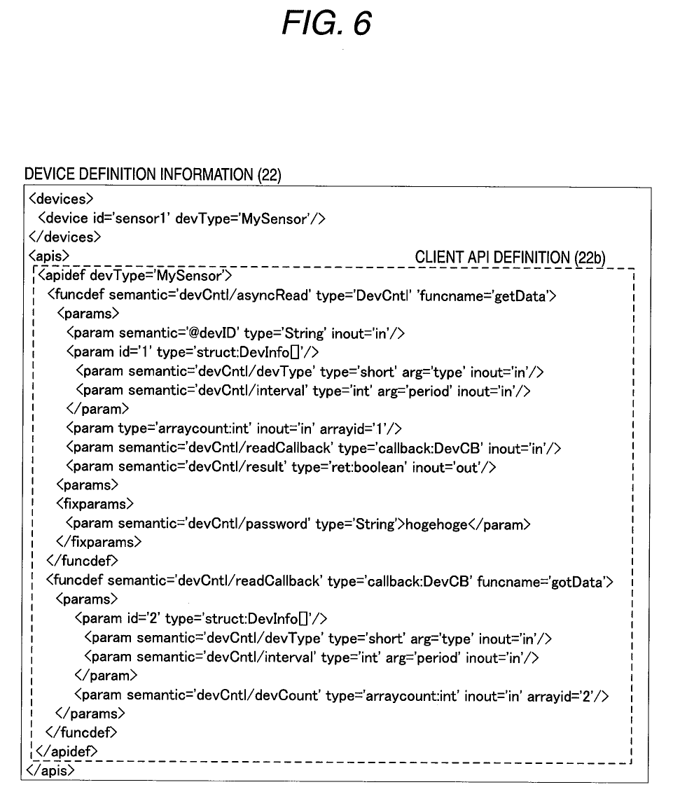

More in detail, the device definition storage section 51 stores therein, as the client API definition 22b, the client API functions for use by the client API 25 with a correlation with the semantic information about each of the client API functions. The device definition storage section 51 also stores therein, as the client API definition 22b, parameters of the client API functions for use by the client API 25 with a correlation with the semantic information about each of the parameters. Moreover, the device definition storage section 51 also stores therein, as the client API definition 22b, fixed values with a correlation with the semantic information about each of the fixed values. The details of such semantic information and the correlation method will be described later by referring to FIGS. 6 and 8 to 13.

The management server 10 is configured to include a configuration information storage section 52, and a management section 15 including a code creation section 11 serving as adaptor creation means, and a configuration management section 12 serving as search means.

The configuration information storage section 52 stores therein configuration information 13 about every sensor 30 found on the system, and various types of information including a sensor control module 13d for use to control the sensors 30. Note that the device definition storage section 51 is to be implemented by using storage means such as the RAM 102 and the HDD 104.

To be specific, the configuration information storage section 52 stores therein a service API definition 13c with a correlation with the semantic information about each of the sensor control modules 28. The service API definition 13c is the one for defining the specification of the service API 27 of the sensor control module 28. The configuration information storage section 52 also stores therein, as the service API definition 13c, the service API functions with a correlation with the semantic information about each of the service API functions. The service API function is the one for use by the service API 27 of the sensor control module 28. The configuration information storage section 52 also stores therein, as a service API definition 22c, the parameters of the service API functions with a correlation with the semantic information about each of the parameters. The parameter of the servicer API functions is the one for use by the service API 27 of the sensor control module 28

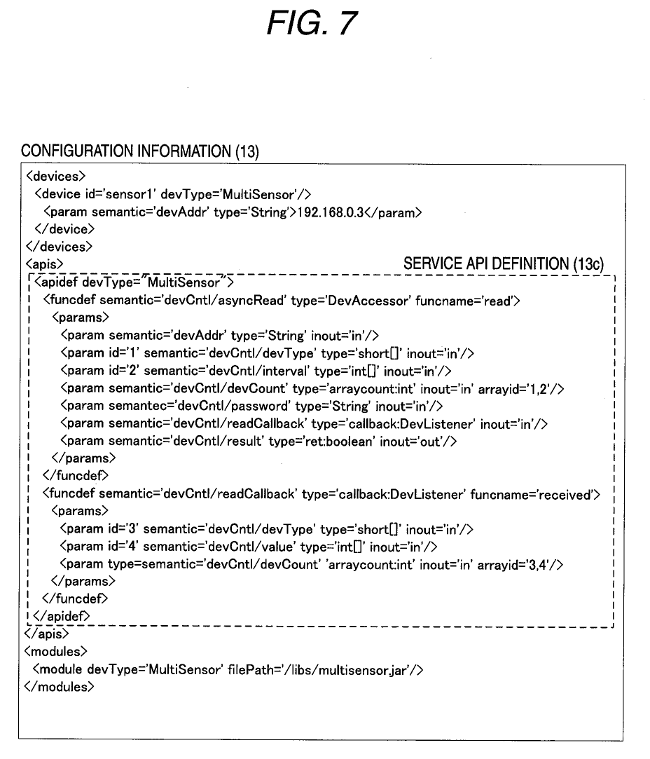

Also in this example, the configuration information storage section 52 stores therein, as the semantic information about the sensor control module 28, i.e., service module semantic information, a device ID 13a and a device attribute 13b. The device ID 13a is the one for identifying the external unit being a control target, and the device attribute 13b serves as attribute information configured by the device name and the position information, for example. Herein, the details of the various semantic information, i.e., the service module semantic information, the service API function semantic information, and the service API function parameter semantic information, and the correlation method will be described later by referring to FIGS. 7 to 13. The management section 15 in the management server 10 is to be implemented in capability terms by the CPU of the management server 10 running a predetermined program.

The configuration management section 12 in the management section 15 serves as an association target selection section, i.e., upon reception of the device ID 22a for identification of the service API definition 13c and the client API definition 22b from the program execution section 50 of the controller 20, the configuration management section 12 determines which of the device IDs 13a in the configuration information 13 matches the provided device ID 22a, and selects the sensor control module 13d corresponding to the device ID 13a determined as such as a target to associate with the application logic 24 corresponding to the client API definition 22b provided by the controller 20. The configuration management section 12 then forwards, to the code creation section 11, the service API definition 13c of the selected sensor control module 13d, and the client API definition 22b provided by the controller 20.

The code creation section 11 in the management section 15 creates an adaptor for use as an intermediary between the application logic 24 selected by the program execution section 50 in the controller 20 and the sensor control module 13d selected by the configuration management section 12. Such adaptor creation is performed based on the client API definition 22b provided by the controller 20, and the service API definition 13d selected by the configuration management section 12.

The code creation section 11 then forwards the resulting adaptor 26 to the controller 20, and this adaptor 26 is installed into the program storage section 19 by the program execution section 50 of the controller 20 for linkage to both the application logic 24 and the sensor control module 28.

In this example, the specification of the client API 25 provided by such an adaptor 26 can be determined by a person who has developed the application logic 24. That is, the device definition information 22 is provided in advance with the device ID 22a of the sensor 30 whichever the person who has developed the application logic 24 wants to use on the system, and the client API definition 22b of the client API 25 to be called from the application logic 24 by the program execution section 50, and only thereby, the code creation section 11 in the management server 10 automatically creates any needed adaptor 26.

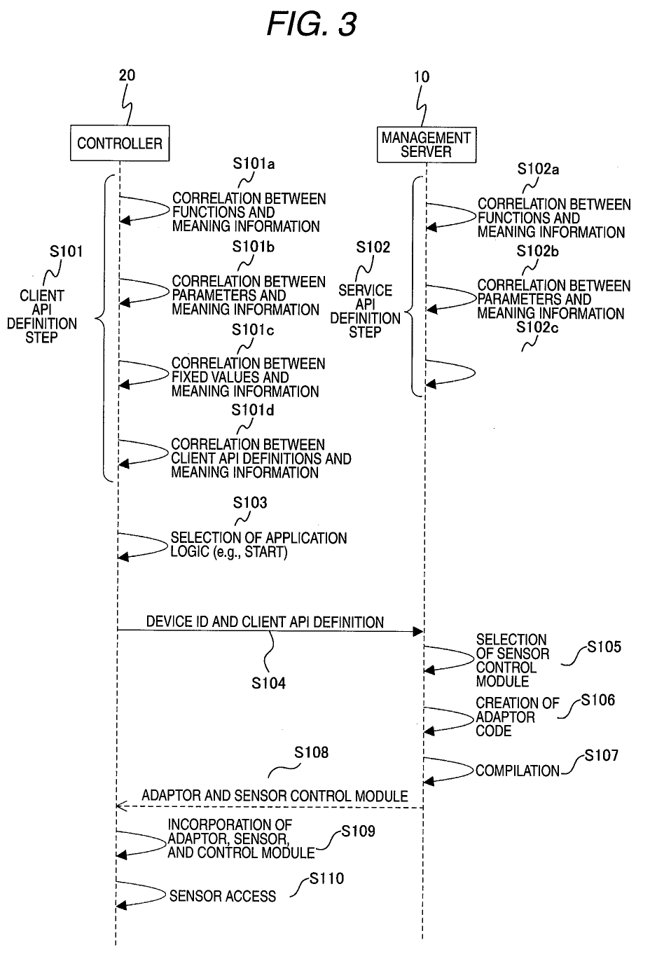

By referring to FIG. 3, described next is the procedure outline for linking of the adaptor 26 to both the application logic 24 and the sensor control module 28.

First of all, in the controller 20, the program execution section 50 to be implemented by the CPU 101 running a client API definition program (not shown) stored in the program storage section 10 executes a client API definition step (S101), i.e., the program execution section 50 creates the client API definition 22b that defines the specification of the client API 25 of the application logic 24, and stores, into the device definition storage section 51, the device definition information 22 in which the resulting client API definition 22b is correlated with the semantic information about the application logic 24. Note here that the method of creating the device definition information 22 using a computer will be described later in detail.

The client API definition step (S101) includes the following processes of S101a to S101d. In the below, these processes will be described in order one by one.

In the course of creating the client API definition 22b, the program execution section 50 establishes a correlation between the client API functions for use by the client API 25 of the application logic 24, and the semantic information about each of the client API functions (S101a).

Also in the course of creating the client API definition 22b, the program execution section 50 establishes a correlation between the parameters of the client API functions for use by the client API 25 of the application logic 24, and the semantic information about each of the parameters (S102b).

Also in the course of creating the client API definition 22b, the program execution section 50 establishes a correlation between the fixed values and the semantic information about each of the fixed values (S101c). The client API definition 22b is basically created by such processes (S101a to S101c).

The program execution section 50 then establishes a correlation between the resulting client API definition 22b, and the semantic information about the application logic 24 corresponding to the client API definition 22b, i.e., device ID 22a, and stores the correlation result into the device definition storage section 51 as the device definition information 22 (S101d).

On the side of the management server 10, the management section 15 executes a service API definition step (S102), i.e., creates the service API definition 13c that defines the specification of the API of the sensor control module 13d, and stores the configuration information 13 into the configuration information storage section 52. The configuration information 13 is the result of correlating the service API definition 13c created as such with the semantic information about the sensor control module 28. Note that the method of creating the configuration information 13 using a computer will be described later in detail.

The service API definition step (S102) includes the following processes of S102a to S102c. In the below, these processes will be described in order one by one.

In the course of creating the service API definition 13c, the management section 15 establishes a correlation between the service API functions for use by the API of the sensor control module 13d, and the semantic information about each of the service API functions (S102a).

Also in the course of creating the service API definition 13c, the management section 15 establishes a correlation between the parameters of the service API function for use by the API of the sensor control module 13d, and the semantic information about each of the parameters (S102b). The service API definition 13d is basically created by such processes (S102a and S102b).

The management section 15 then establishes a correlation between the resulting service API definition 13c, and the semantic information about the sensor control module 13d corresponding to the service API definition 13c (the device ID 13a and the device attribute 13b in this example), and stores the correlation result into the configuration information storage section 52 as the configuration information 13 (S102c).

Then in the controller 20, the program execution section 50 to be implemented by the CPU 101 running the adaptor creation request program 23 selects any of the application logics 24 corresponding to an external unit being a control target (S103) When the CPU 101 of the controller 20 starts running the application logic 24, for example, e.g., when a user requests to start the application logic 24, the program execution section 50 selects any of the application logics 24 as a client module for data acquisition from the sensor 30.

The program execution section 50 to be implemented by the CPU 101 running the adaptor creation request program 23 acquires, from the device definition storage section 51, the client API definition 22b corresponding to the selected application logic 24, and the device ID 22a corresponding to the application logic 24. Such acquisition results are forwarded to the management server 10 (S104).

The configuration management section 12 to be implemented in capability terms by the CPU 101 running a predetermined program (not shown) acquires, in the management server 10, the device ID 22a corresponding to the application logic 24 selected by the program execution section 50. The configuration management section 12 then determines which of the device IDs 13a matches thus acquired device ID 22a, and selects any of the sensor control modules 13d corresponding to thus determined device ID 13a as a target to associate with the application logic 24 selected by the program execution section 50 (S105).

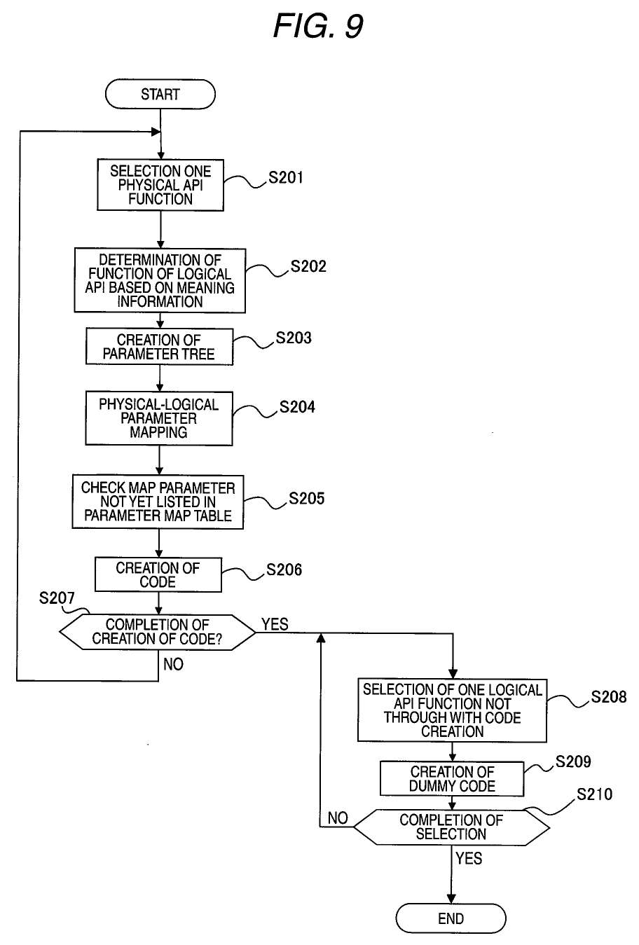

The code creation section 11 to be implemented in capability terms by the CPU 101 running a code creation program (not shown) creates a source code of the adaptor for use as an intermediary between the application logic 24 selected by the program execution section 50 and the sensor control module 13d selected in S105 (S106). This source code creation is performed based on the client API definition 22b of the application logic 24 selected by the program execution section 50, and the service API definition 13c of the sensor control module 13d selected by the configuration management section 12 in S105. The resulting source code is compiled so that an execution file is created (S107). In this example, the source code of the adaptor is created by the code creation section 11 in the management server 10, but alternatively, the source code may be created on another computer, and the resulting source code may be then uploaded to the management server 10. Such an adaptor code creation process (S106) will be described later in more detail by referring to FIGS. 9 to 17.

Note that the adaptor code creation process (S106) in this example includes the following processes.

1. Process of Correlating Functions

In this process, the code creation section 11 establishes a correlation between the client API functions for use by the API of the application logic 24, and the service API functions for use by the API of the sensor control module 13d.

To be specific, in this process, the code creation section 11 executes

a step of selecting any of the service API functions for use by the API of the sensor control module 13d selected by the configuration management section 12 in S105,

a step of acquiring the service API function semantic information corresponding to the selected service API function, determining the client API function semantic information matching thus acquired service API function semantic information, and selecting, as a target to associate with the selected service API function, the client API function corresponding to thus determined client API function semantic information for use by the application logic 24 selected by the program execution section 50 in S105, and

a step of creating, based on the selected service API function and the selected client API function, a part of the adaptor for use as an intermediary between the service API function and the client API function.

2. Process of Correlating Parameters

In this process, the code creation section 11 establishes a correlation between parameters sharing the same semantic information in the functions correlated to each other in the above process of 1.

To be specific, in this process, the code creation section 11 executes

a step of selecting any of the parameters of the service API function selected in the above process of 1,

a step of acquiring the service API function parameter semantic information corresponding to the selected parameter of the service API function, determining the client API function parameter semantic information matching thus acquired service API function parameter semantic information, and selecting, as a target to associate with the selected parameter of the service API function, the parameter of the client API function selected in the above process 1 and corresponding to the determined client API function parameter semantic information, and

a step of creating, with a correlation between the selected parameter of the service API function and the selected parameter of the client API function, a part of the adaptor for use as an intermediary between the service API function and the client API function selected in the above process of 1.

3. Process of Correlating Parameters and Fixed Values

In this process, the code creation section 11 establishes, in the functions correlated to each other in the above process of 1, a correlation between the parameters of the service API function and the fixed values in the client API definition 22b showing a match of the fixed value semantic information.

To be specific, in this process, the code creation section 11 executes

a step of identifying, from the parameters of the service API function selected in the above process of 1, any of the parameters having the semantic information being the fixed value semantic information,

a step of selecting, as a target to associate with the identified parameter of the service API function, from the fixed values found in the client API definition 22b provided by the program execution section 50 of the controller 20, any of the fixed values corresponding to the semantic information that matches the fixed value semantic information of the identified parameter of the service API function, and

a step of correlating the parameter of the client API function and the parameter of the service API function selected in the above process of 2, substituting the selected fixed value to the identified parameter of the service API function, and creating a part of the adaptor for use as an intermediary between the client API function and the service API function selected in the above process of 1. [I1] Herein, the above processes of 1 to 3 will be described later in more detail by referring to FIGS. 9 to 13.

The configuration management section 12 forwards, to the controller 20, the adaptor 26 created by the code creation section 11, and the sensor control module 13d selected in S105 (S108).

On the side of the controller 20, the program execution section 50 to be implemented in capability terms by the CPU 101 running the application logic 24, the adaptor 26, and the sensor control module 28 incorporates the adaptor 26 and the sensor control module 13d provided as above into the program storage section 49 (S109), and using the adaptor 26, associates the application logic 24 and the sensor control module 28 with each other. The program execution section 50 then uses the capabilities of the sensor control module 28 via the incorporated adaptor 26 (S110).

In the above description, the adaptor 26 is incorporated at the time when an application is started, but alternatively, the adaptor 26 may be incorporated into the program storage section 49 when the program execution section 50 makes an attempt to access the sensor 30, i.e., on-demand download. To be specific, a so-called “bootstrap adaptor” may be incorporated in advance into the program storage section 49. The bootstrap adaptor is the one having the capabilities of downloading the adaptor 26 and the sensor control module 28 from the management server 10 for incorporation into the program to be executed, i.e., the adaptor creation request program 23. If this is the configuration, the program execution section 50 to be implemented by the CPU 101 running the bootstrap adaptor asks the management server 10 to create an adaptor, and the resulting adaptor 26 is incorporated into the program storage section 49. Such adaptor creation and incorporation is taken place at a timing when the program execution section 50 to be implemented in capability terms by the CPU 101 running the application logic 24 makes an attempt to access the sensor 30. Herein, the bootstrap adaptor is used only when the program management section 49 is not provided with the adaptor 26. Alternatively, the process procedure based on such a bootstrap adaptor may be executed based on the adaptor creation request program 23.

As described above, in this example, the adaptor 26 is automatically created even when the specification of the service API 27 is changed for use to control the sensor 30. This accordingly eliminates the need for changing the specification of the client API 25, thereby favorably leading to the effects of not requiring correction of the application logic 24.

Moreover, in this example, when the sensor 30 is replaced with another of a different type, there only needs to rewrite the device attribute 13b and the service API definition 13c of the configuration information 13, thereby not requiring to correct the application logic 24. This thus allows operation check or others in the system development environment using the sensor 30 of a type different from the sensor that will be put in use under the operation environment, and the resulting developed system can be highly flexible.

When the sensor 30 is frequently replaced to another, the device IDs 13a and 22a are preferably not those being individually allocated to the sensors but those indicating the roles and capabilities of the sensors 30, e.g., the temperature detection and humidity detection. This is because when the device IDs 13a and 22a are those being individually allocated to the sensors 30, for every replacement of the sensor 30, the device IDs 13a and 22a are required to be changed in the configuration information 13 and the device definition information 22. By the device IDs 13a and 22a indicating the roles of the sensors 30 as such, on the other hand, when the sensor 30 is replaced with another having the same role and capabilities, the device IDs 13a and 22a are not required to be changed.

In the below, the procedure for automatically creating the adaptor 26 is described in detail by way of a specific example. In the description below, among the various semantic information, i.e., the client module semantic information, the client API function semantic information, the client API function parameter semantic information, the service module semantic information, the service API function semantic information, and the service API function parameter semantic information, any information indicating the use and details of the functions and any information indicating the use and details of the parameters are denoted as semantic information, and the remaining semantic information is denoted by each different name of information, e.g., device ID, type information, function name, variable name, and attribute requirements.

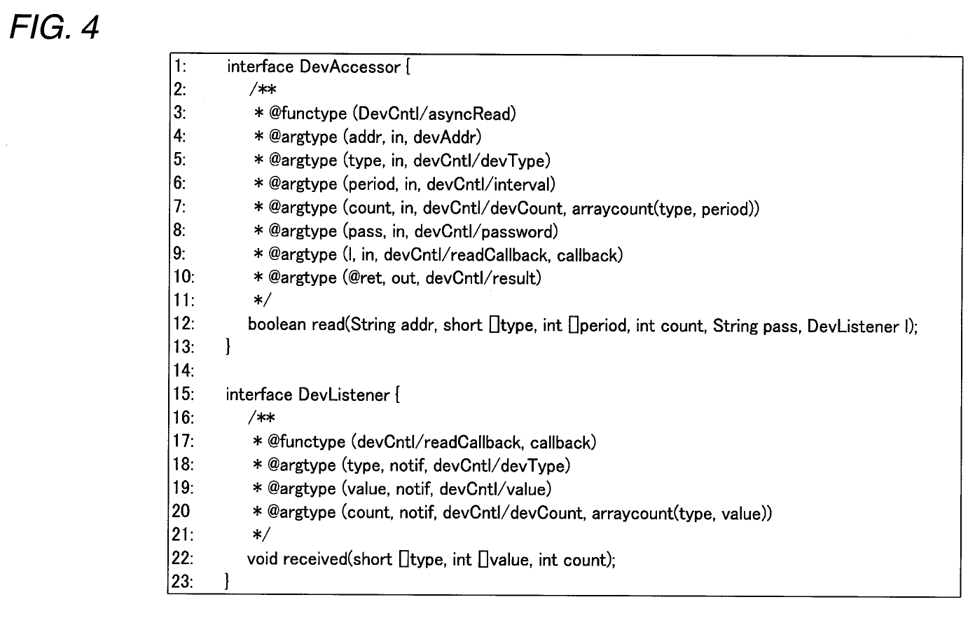

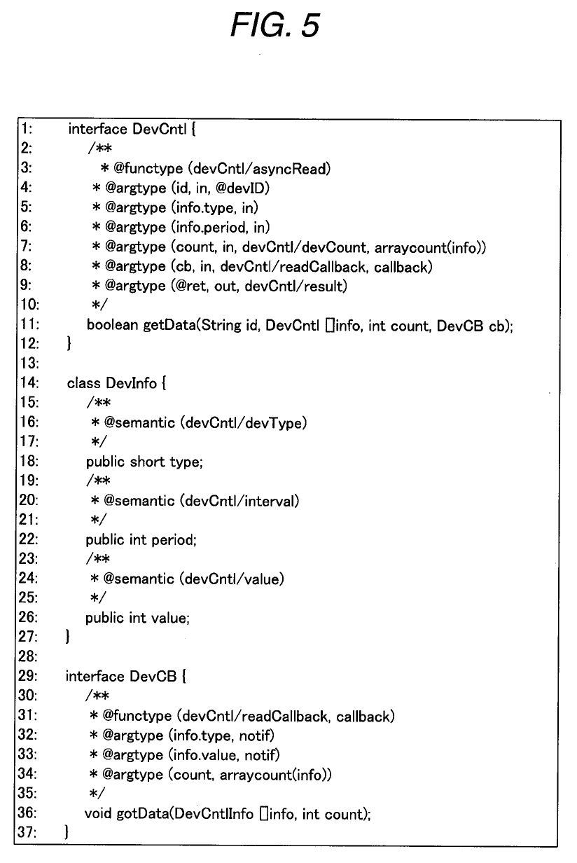

First of all, FIG. 4 shows an exemplary service API 27, and FIG. 5 shows an exemplary client API 25. For data collection from the sensor 30 using the service API 27, a “read” function in a line 12 of FIG. 4 is used. In this example, the “read” function returns, by boolean, the result about whether the process has succeeded or not, i.e., true when the process has succeeded. The sensor 30 is assumed as including a plurality of sensors (internal sensors) varying by type, e.g., temperature sensor, humidity sensor, and light-amount sensor, and is expected to measure the temperature, the humidity, and the amount of light all at once.

The first argument “addr” of the “read” function denotes the address of the sensor 30, the second argument “type” thereof denotes the type of the internal sensor(s) in charge of actual measurement, the third argument “period” thereof denotes the sensing interval, the fourth argument “count” thereof denotes the number of elements of the second argument “type” and that of the third argument “period”, the fifth argument “pass” thereof denotes the password for using the sensor 30, and the sixth argument “1” thereof denotes the callback object for asynchronous data reception from the sensor.

Any same index value in the array of “type” and the array of “period” corresponds to each other, i.e., assuming that the array index is “i”, the sensing interval of the internal sensor of a type designated by type[i] is designated by period[i].

The reason why the “pass” is not the array is that the password is requested not by the internal sensors but by the sensor 30 itself. That is, after authenticating the password input by a user, the sensor 30 allows the user to access the internal sensors.

The specification of a callback object for use to collect data from the sensor 30 is found in lines 15 to 23 of FIG. 4. After data reception from the sensor 30, a “received” function is called from the callback object designated as the “read” function. The first argument “type” of the “received” function denotes the type of the internal sensor through with sensing, the second argument “value” thereof denotes the value of the data provided by the internal sensor, and the third argument “count” thereof denotes the number of elements of the first argument “type” and that of the second argument “value”. Any same index value in the array of “type” and the array of “value” corresponds to each other, i.e., assuming that the array index is “i”, the value provided by the internal sensor of a type designated by type[i] is designated by value[i].

On the other hand, for data collection from the sensor 30 using the client API 25, a “getData” function in a line 11 of FIG. 5 is used. In this function, a “DevInfo” class carries collectively therein information about the arguments of “type”, “period”, and “value” of the “read” and “received” functions of the service API. Comparing with these functions of the service API, with the “getData” function of the client API, no argument is designated for provision to “pass” (password) being a parameter of the “read” function of the service API. Moreover, with the “read” function of the service API, the sensor 30 is designated by “addr” (address), but with the “getData” function of the client API, the sensor 30 is designated by “id” (device ID). As to the remaining specification, there is no essential difference between the client API and the service API.

In the client API, the first argument “id” of the “getData” function denotes the device ID of the sensor 30, the second argument “info” thereof denotes the type of the internal sensor in charge of measurement and the sensing interval, the third argument “count” thereof denotes the number of elements of the second argument “info”, and the fourth argument “cb” thereof designates the callback object for asynchronous data reception. The second argument “info” is a DevInfo-type object, and in this function, only class members of “type” and “period” are used. The class member of “type” denotes the type of the internal sensor in charge of measurement, and the class member of “period” denotes the sensing interval.

The specification of the callback object of the client API is found in lines 29 to 37 of FIG. 5. After data reception from the sensor 30, the “gotData” function is called. The first argument “info” of the “gotData” function is provided with the type of the internal sensor through with sensing, and the value of the data provided by the internal sensor as the array of the DevInfo-type object. The second argument “count” of the “gotData” function is provided with the number of elements of the first argument “info”. Moreover, the “gotData” function is provided with the DevInfo-type object, but in this function, only the class members of “type” and “value” are used.

FIG. 6 shows a specific example of the device definition information 22, and FIG. 7 shows a specific example of the configuration information 13. In the device definition information 22, the information below the element of “devices” corresponds to the device ID 22a of FIG. 1, and this portion includes a list of the sensors 30 available for use by the program execution section 50. The element of “device” being a sub element of the element of “devices” corresponds to each of the sensors 30. The “id” attribute of the element of “device” shows the device ID of the sensor, and the “devType” attribute shows the type of the sensor. The device ID designated as the “id” attribute is used as the argument of the client API 25. The “devType” attribute is designated for representing the correlation with the client API definition 22b, and serves well as long as it is unified in one application.

On the other hand, in the configuration information 13 (FIG. 7), the information below the element of “devices” corresponds to the device ID 13a and the device attribute 13b of FIG. 1, and this portion includes a list of the sensors 30 found in the system. To be specific, similarly to the device definition information 22, the element of “device” being a sub element of the element of “devices” shows information about each of the sensors 30. That is, the “id” attribute of the element of “device” shows the device ID of the sensor, and the “devType” attribute shows the type of the sensor.

The “devType” attribute is designated for representing the correlation with the service API definition 13c, and is required to be unified in the configuration information 13.

For the element of “param” being a sub element of the element of “device”, the attribute parameter of the device attribute 13b is designated. The attribute parameter is provided as the argument of the corresponding service API when the sensor 30 is put in use.

The client API definition 22b is provided in the device definition information 22 of FIG. 6, below the element of “apidef” being a sub element of the element of “apis”. The element of “apidef” is defining the specification of the API of one module. The “devType” attribute of the element of “apidef” designates the correlation with the device ID described as the “id” attribute of the element of “device”.

Similarly to the configuration of the device definition information 22, in the configuration information 13, the service API definition 13c is found below the element of “apidef” being a sub element of the element of “api”. In the client API definition 22b and the service API definition 13c, the method of information description into the portion below the element of “apidef” is the same, and thus in the below, only the client API definition 22b is described in detail for the method of information description to the portion below the element of “apidef”, and no specific description is given thereabout for the service API definition 13c.

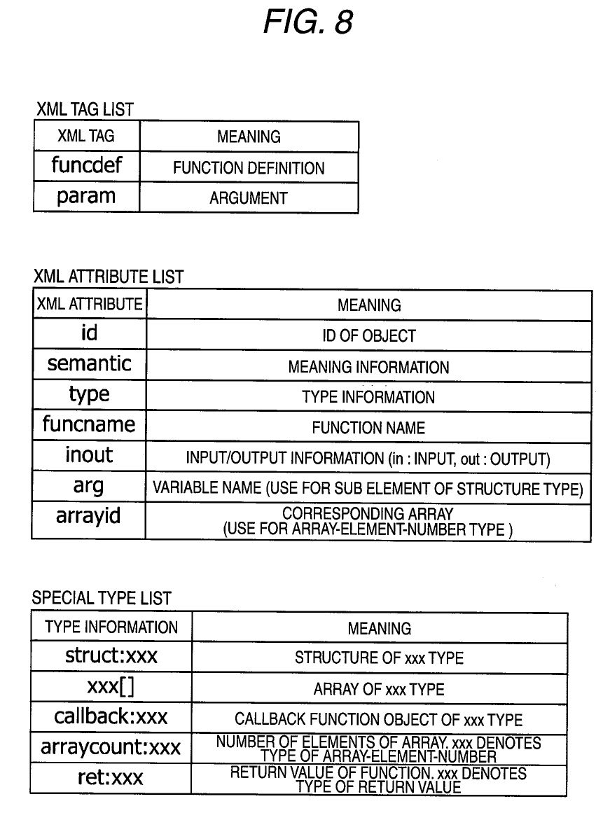

The element of “funcdef” being a sub element of the element of “apidef” will be the client API definition for one function. The API for use of a module is generally configured by a plurality of functions, and thus used is such a form that allows definition of a plurality of functions, i.e., the portion below the element of “apidef” can include a plurality of elements of “funcdef”. Note that FIG. 8 shows information to be described in the portion below the element of “funcdef”, i.e., XML (Extensible Markup Language) tag, XML attribute, and attribute type, and their meanings. Described below are the main points thereof.

The “type” attribute of the element of “funcdef” shows type information about an object whose function is defined, and the “funname” attribute shows the name of the function. In FIG. 6 example, for defining the member function “getData” of the object of a “DevCntl” type, the “type” attribute is designated with “DevCntl”, and the “funcname” attribute is designated with “getData”.

The element of “params” being a sub element of the element of “funcdef” includes information about arguments and return values of the function, and the element of “fixparams” being a sub element of the element of “funcdef” shows a fixed variable being a fixed value. Hereinafter, the arguments and the return values are collectively referred to as “parameters”. The fixed variable is provided when the need arises to designate, for the service API, any parameter not taken as an argument by the client API.

To be specific, the “read” function of the service API of FIG. 4 requires the designation of a password, but the “getData” function of the client API of FIG. 5 does not require the designation of a password. As such, the “read” function of the service API cannot be called from the “getData” function of the client API unless some modification is made. In consideration thereof, a password may be provided in advance in the client API definition 22b as a fixed variable, whereby the code creation section 11 becomes able to create the adaptor 26 serving to pass the password being a fixed variable to the service API.

The elements of “param” have a one-to-one relationship with the parameters. To be specific, the type information about the parameters is provided as the “type” attribute, and the input/output information about the parameters, i.e., information indicating which of data input and data output uses the argument, is provided as the “inout” attribute. When the argument is a structure like a class object, the input/output information is determined with respect to each of the class members, and thus the input/output information of the parameters is not provided.

When the argument is a structure like a class object, for representing the configuration thereof, the element of “param” may be described with a hierarchical structure. To indicate that the object is a structure, the “type” attribute, i.e., type information, of the parameter may be provided as “struct: (object type)”. In FIG. 6 example, the second argument of the “getData” function is an array of DevInfo type, and thus the “type” attribute of the corresponding element of “param” shows “struct: DevInfo[]”. When the type information is represented by an array, the “type” attribute may be designated as “(type information)[]”.

The “struct:DevInfo[]” is a combination of the structure and the array, and thus is including “[]”. When the function takes the array as an argument, there needs to additionally designate the “number of elements of array” as an argument of the function, and thus when a parameter corresponds to “number of elements of array”, the “type” attribute of the parameter may include “arraycount: (type information)”.

The type information designated by “arraycount” is that of a parameter representing the number of elements, and generally is a type representing an integer, e.g., short, int, and long. Moreover, when a parameter corresponds to “number of elements of array”, the “arrayid” attribute may be used to designate a list of the “id” attributes of the array parameter whose parameter designates the number of elements. As such, the array parameter to be designated has to be designated in advance with the “id” attribute. In FIG. 6 example, the second argument of the “getData” function is the array, and the number of elements of the array is designated as a third argument. The relationship between the third and second arguments is designated using the “id” attribute and the “arrayid” attribute.

Herein, when a parameter represents the number of elements of a plurality of arrays, as the “arrayid” attribute, a list of the “id” attributes of the array parameter may be designated using delimiters like commas. FIG. 7 shows such an example of the service API definition 13c.

When a parameter is a callback object, the “type” attribute shows “callback: (callback object type)”, and the callback function to be defined in the callback object can be defined by specification separately by the element of “funcdef”. In FIG. 6 example, the member function “gotData” of a “DevCB-type” callback object is defined.

In FIG. 6 example, the parameters are each set with the “semantic” attribute, which represents the semantic information of each of the parameters. For module-to-module interface conversion, there needs to determine the correlation between the functions and between the parameters. For determining such a correlation, pattern matching may be performed through comparison of the type information and configuration, but if this is the case, however, the parameters to be handled by the interfaces may vary by type information and configuration. Therefore, such a method may fail to establish the correlation between the interfaces.

In consideration thereof, the functions and the parameters are each provided with semantic information to establish a correlation between the functions and parameters showing a match of the semantic information, thereby establishing a correlation between the functions and parameters without fail. Moreover, even if the parameters vary by type information, if amatch of the semantic information is observed therebetween, a correlation may be established therebetween by casting (converting parameter type), for example.

In FIG. 6 example, the “semantic” attribute shows “devCntl/asyncRead for the element of “funcdef” corresponding to the definition of the “getData” function of the client API, and this is the semantic information indicating “asynchronous data reading through device control”. The function of the service API having the same semantic information is the “read” function, thereby being able to correlate the “getData” function of the client API to the “read” function of the service API. Moreover, by representing the semantic information as a character string of a hierarchical structure using delimiters such as slashes, the concept can be represented hierarchically.

Some of the semantic information is defined in advance in this process framework, i.e., process of automatically creating an adaptor. To be specific, the first argument “@devID” of the “getData” function of FIG. 6 is defined in advance as the semantic information with the meaning of device ID. As such, the code creation section 11 creates a source code with which the argument designated with “@devID” is handled as the device ID.

Herein, the device definition information 22 (FIG. 6) and the configuration information 13 (FIG. 7) may be created manually, but if so, the information description will be complicated and annoying. As such, as shown in lines 3 to 10 of FIG. 4, a person in charge of development may provide various types of information about the functions and the parameters in a source code as extended meta information, and a computer may perform lexical analysis of the source code, thereby automatically creating the client API definition 22b and the service API definition 13c in the device definition information 22 and the configuration information 13, respectively. Such automatic definition creation is performed based on the description in the source code, i.e., function, type information about arguments, and the above-described extended meta information. Instead of directly describing the device definition information 22 and the configuration information 13, describing the extended meta information in a source code may be intuitively easy to understand so that the work load can be saved for the person in charge of development.

In the below, by referring to FIG. 4, described is the extended meta information to be provided in a source code. A line 3 of FIG. 4 includes the description of “@functype”, and this is the extended meta information about the function. The first argument of “@functype” is provided with semantic information, and the second argument is provided with the remaining extended information. The example with the line 3 of FIG. 4 does not show the second argument, but the example with a line 17 of FIG. 4 shows the second argument of “callback”, and this tells that the function is the callback function.

The portion of lines 4 to 10 of FIG. 4 includes the description of “@argtype”, and this is the extended meta information about the arguments. The first argument of “@argtype” shows the argument name designating the extended meta information, the second argument thereof shows input/output information, the third argument thereof shows semantic information, and the fourth argument thereof shows the remaining extended information. In a line 10 of FIG. 4, the first argument of “@argtype” shows “@ret”, and this “@ret” is a special argument name meaning “return value of the function”.

Moreover, a line 16 of FIG. 5 shows “@semantic”, and this is semantic information. The extended meta information to be added to the members of a structure is only the semantic information, and thus only “@semantic” is provided as the member as shown in the drawing.

In the adaptor code creation process of FIG. 3 (S106), the code creation section 11 reads the client API definition 22b and the service API definition 13c, and based on the information about the parameter, i.e., type information, semantic information, and input/output information, a correlation is established between the parameters. Based on the resulting correlation, the code creation section 11 creates a source code of the adaptor 26 for use of conversion between the parameters. FIG. 9 shows the internal flow of this adaptor code creation process (S106). In the below, by referring to FIG. 9, the procedure for the adaptor code creation process is described in detail.

The code creation section 11 reads the service API definition 13c found in the configuration information 13, and selects one of the functions configuring the service API (S201).

The code creation section 11 then reads the client API definition 22b received from the controller 20, i.e., received in S104 of FIG. 3, and determines which of the functions of the client API has the same semantic information as the function of the service API selected in S201 (S202).

When the “read” function of the service API is selected in S201 (refer to FIG. 7), the “semantic” attribute indicating the semantic information of this function is “devCntl/asyncRead”, and thus the client API definition 22b is searched for the function of the client API having the same “semantic” attribute. As a result, the “getData” function (refer to FIG. 6) is acquired as a search result. Note here that when no search result is derived, i.e., there is no such function of the client API having the same semantic information as the function of the service API selected in S201, a program may be so designed in advance that the procedure goes to S201.

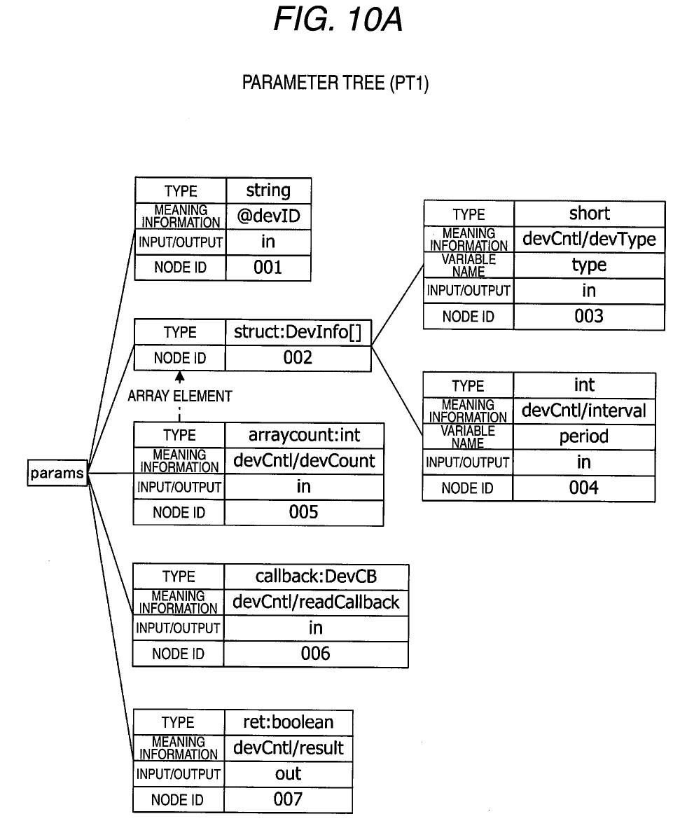

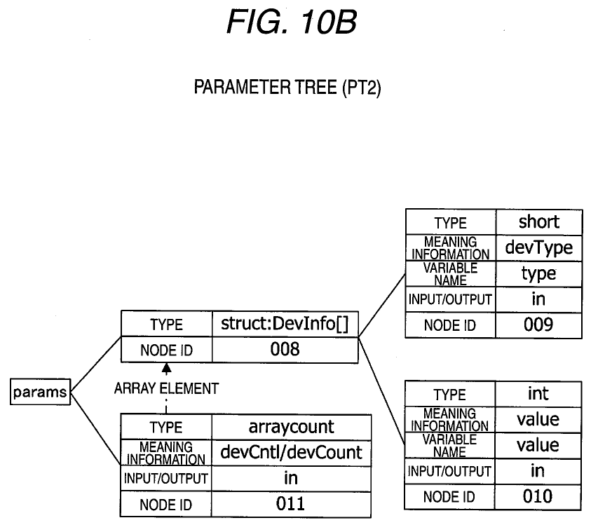

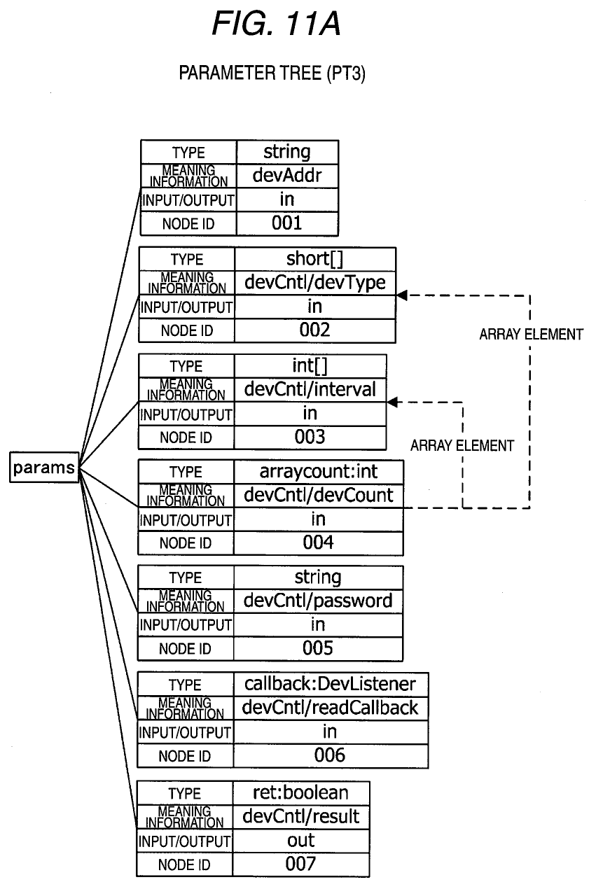

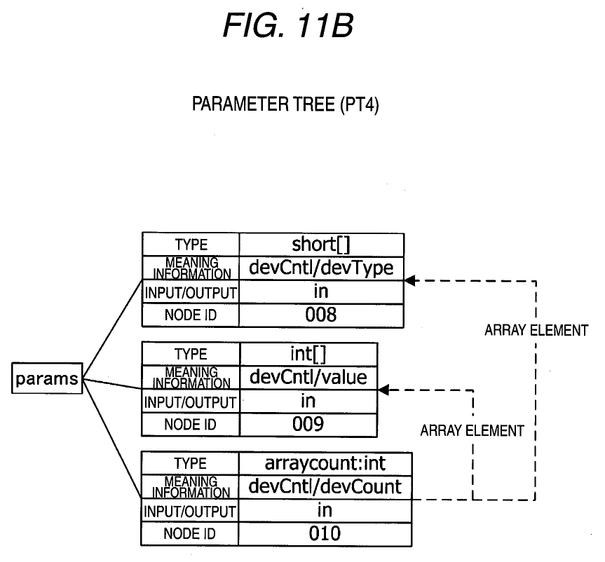

The code creation section 11 then creates parameter trees (PTs) of FIGS. 10A to 11B based on information about the arguments of the function of the service API selected in S201, and that of the client API selected in S203, i.e., portion below the element of “params” of FIGS. 6 and 7, respectively (S203).

When the “read” function of the service API is selected in S201, and when the “getData” function of the client API is acquired in S202, created are a parameter tree corresponding to the “read” function of the service API, i.e., PT3 of FIG. 11A, and a parameter tree corresponding to the “getData” function of the client API, i.e., PT1 of FIG. 10A.

In the parameter tree creation process (S203), the code creation section 11 makes an addition of nodes to the portion below a node “params” being a root node of the parameter tree. For this addition of node, nodes corresponding to the arguments of the function are added in order of the arguments. In FIGS. 10A to 11B, the order for child nodes (sibling nodes) sharing the same parent node is in the ascending order by argument. For example, the first argument of the “getData” function of the client API is the device ID, and in the parameter tree (PT1) corresponding to the function, the first child node of the element of “params” (node ID=001) is the node corresponding to the device ID. Herein, for representing such a relationship of the order on a computer, the sibling nodes may be represented in the form of an ordered list, for example.

The nodes configuring a parameter tree (PT) has setting items of “type”, “semantic information”, “variable name”, “input/output”, and “node ID”. The setting item of “type” takes a value found in the “type” attribute of the element of “param” (refer to the client API definition and the service API definition of FIGS. 6 and 7). The setting item of “semantic information” takes a value found in the “semantic” attribute of the element of “param”, and the setting item of “variable name” takes a value found in the “arg” attribute of the element of “param”. The setting item of “input/output” takes a value found in the “inout” attribute of the element of “param”. The setting item of “node ID” for setting to the node is automatically numbered by the code creation section 11 not to overlap in one function. Herein, the “params” node being a root node of each of the parameter trees (PTs) is a special node, and does not have the setting items as above.

The relationship between the array parameters and the array-element-number parameters is set based on the “id” attribute and the “arrayid” attribute of the element of “param”. For example, the second argument of the “getData” function of the client API is the array, and the third argument is the number of the elements thereof. In FIG. 6, the relationship between the arguments is correlated by the “id” attribute and the “arrayid” attribute”. In the parameter tree (PT1), the node corresponding to the second argument (node ID=002) is correlated as the array element of the node corresponding to the third argument (node ID=005). Herein, to represent the correlation about the arrays on a computer, a member variable may be provided to the structure representing each of the nodes for indicating the correlation target, and the member variables may be each set with an ID of the node of the correlation target, or with an address of the structure representing the node being the correlation target.

Herein, in FIGS. 10A to 11B, to make the drawings easier to see, when there is no value for any of the setting items of the nodes, the setting item(s) themselves are not shown. For example, in the parameter tree (PT1) of FIG. 10A, for the node with the node ID of 002, there is no value for the setting items of “semantic information” and “input/output information”, and thus the setting items do not include the “semantic information” and the “input/output information”.

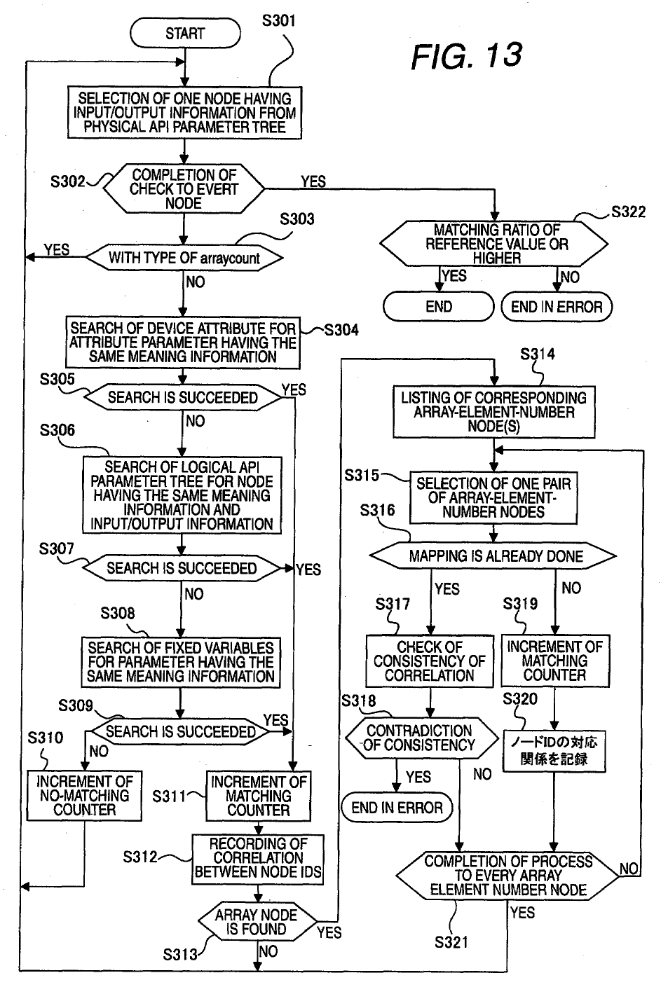

Thereafter, the code creation section 11 refers to the parameter trees (PTs) created in S203, and to any of the nodes configuring the parameter trees (PTs) of the service API set with the input/output information, the nodes configuring the parameter trees (PTs) of the client API are correlated for parameter mapping, thereby creating a parameter map table (MT) (S204). Note here that the details of such parameter mapping will be described in detail later by referring to FIG. 13.

The correlation among the parameters is determined based on the setting items set to each of the nodes, i.e., “type”, “semantic information”, and “input/output information”.

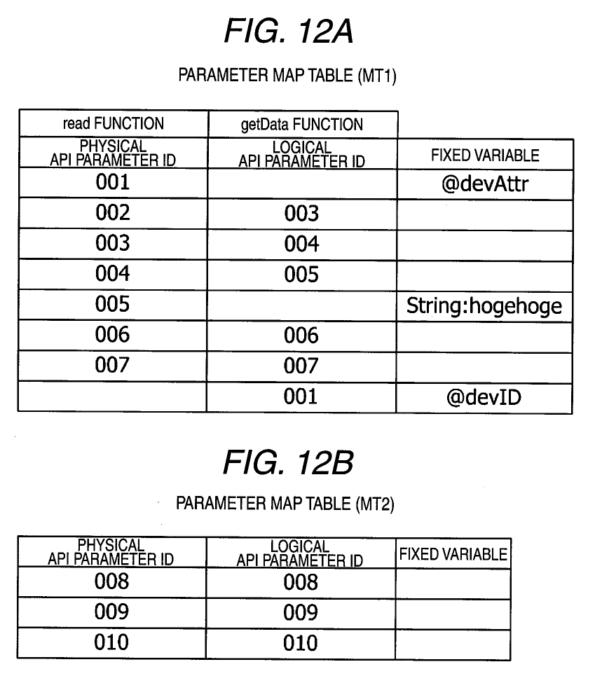

The code creation section 11 then registers the resulting correlation to the parameter map tables (MTs) of FIGS. 12A and 12B.

The parameter map table (MT) is created to every function. Forexample, the parameter map table (MT1 of FIG. 12A) includes the correlation between the “getData” function of the client API and the “read” function of the service API, and the parameter map table (MT2 of FIG. 12B) includes the correlation between the “gotData” function of the client API and the “received” function of the service API.

The parameter map table (MT) is configured by a service API parameter ID, a client API parameter ID, and a fixed variable, and therein, the node ID of a node in the corresponding parameter tree (PT) is set as a service API parameter ID and a client API parameter ID in the same entry of the parameter map table (MT).

For example, the node with the node ID of 002 in the parameter tree (PT3 of FIG. 11A) of the “read” function of the service API is a parameter representing the type of the internal sensor of the sensor 30, and is corresponding to the node with the node ID of 003 in the parameter tree (PT1 of FIG. 10A) of the “getData” function of the client API. Accordingly, in the parameter map table (MT) of FIG. 12A, the client API parameter ID is 003 in an entry with the service API parameter ID of 002.

In a case where there is no parameter of the client API corresponding to the parameter of the service API, when there needs to forward a value to the parameter of the service API, by this process (S204), the parameter designated as a fixed variable in the client API definition 22b (FIG. 6), i.e., in the portion below the element of “fixparams”, may be registered as a fixed variable of the parameter map table (MT). As a result, in the code creation process (S205) that will be described later, an adaptor code is created for providing the fixed variable found in the client API definition 22b as a parameter of the function of the service API.

For providing the attribute parameter designated in the device attribute 13b in the configuration information 13 as the parameter of the function of the service API 27, a correlation is established between the parameter of the function of the service API 27 and the attribute parameter. For indicating the correlation established as such, an entry in the parameter map table (MT) for the parameters of the function of the service API 27 is provided with “@devAttr” as a fixed variable. In this manner, the code creation section 11 creates an adaptor for the program execution section 50 to acquire information for use to access the sensor 30 at the time of running of the adaptor, i.e., attribute parameter in the configuration information 13.

For the application logic 24 to access the service API 27 via the client API 25, for example, the attribute parameter may be needed to be forwarded as an argument to the parameters of the function of the service API 27. The attribute parameter in this case is the one for identifying the sensor 30 being a control target on the network, e.g., IP address and port number. In this case, the client API definition 22b may be provided in advance with such an attribute parameter, but if the attribute such as IP address is changed due to the replacement of the sensor 30, for example, the need arises to rewrite the client API definition 22b in each of the client devices, e.g., controller 20. This will be very complicated and annoying. In consideration thereof, as in the first example, the attribute parameters of a device may be put under the collective management of the management server 10 instead of in the client API definition 22b. If this is the case, even if the attribute of the sensor 30 is changed, there only needs to update the attribute parameters in the management server 10, and this is easy to do.

In this example, the entry of the parameter map table (MT) is provided with a fixed variable of “@devAttr” so that, in the code creation process (S205), a code is created for calling the “findDevAttr” function for acquiring the value parameter of the device attribute of the sensor 30. The program execution section 50 of the controller 20 then runs this “findDevAttr” function, thereby acquiring the value parameter of the device attribute from the management server 10. The resulting value parameter can be forwarded as an argument to the parameter of the function of the service API 27.

When this process (S204) is executed to the parameters of the “read” function of the service API and those of the “getData” function of the client API, the parameter map table (MT1) of FIG. 12A is created.

The code creation section 11 then checks the list of the nodes configuring the parameter trees (PTs) of the client API, and searches the nodes of the parameters of the client API with the input/output information for any node whose node ID is not yet registered in the parameter map table (MT). The node ID(s) of thus found node(s) are then registered into the client API parameter ID of the parameter map table (MT) (S205). If with the parameter tree (PT1), for example, the node with the node ID of 001 is not yet registered in the parameter map table (PT), and thus the code creation section 11 creates a new entry to the parameter map table (PT), and registers the node ID (001) to the client API parameter ID.

At the time of registration as such, the code creation section 11 refers to the semantic information provided to the nodes of the parameter tree (PT), and when any of the semantic information indicates “@devID”, provides “@devID” as a fixed variable of the corresponding parameter map table (MT). In the example of this parameter tree (PT1 of FIG. 10A), because the semantic information of the node registered as such (node ID=001) is “@devID”, the fixed variable in any corresponding entry in the parameter map table (MT1 of FIG. 12A) shows “@devID”.

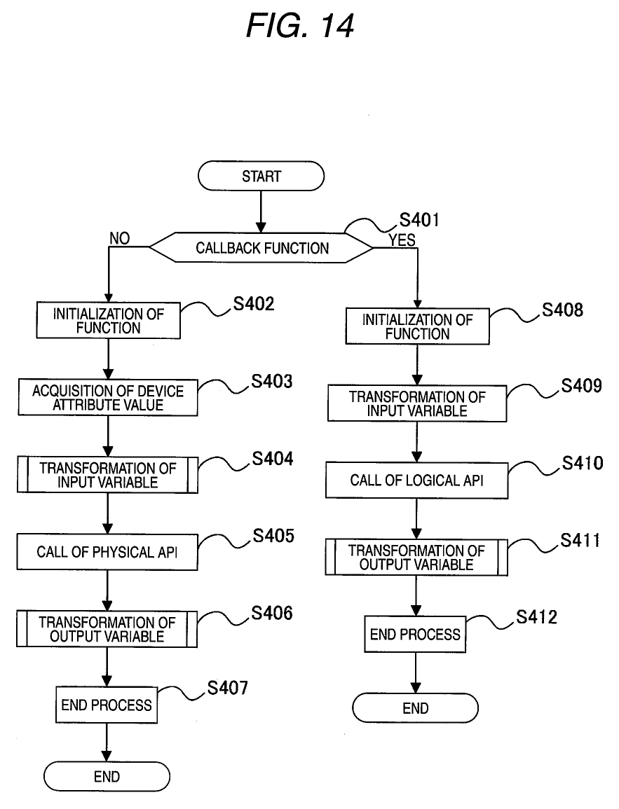

The code creation section 11 then creates a source code of the adaptor 26 based on the parameter trees (PTs) created in S203, and the parameter map table (MT) created in S204 and S205 (S206). The specific method for creating a source code will be described later by referring to FIGS. 14 to 17.

The code creation section 11 then checks whether every function of the service API is through with creation of the adaptor code or not (S207), and when there is any function not yet through with creation of the adaptor code, the above procedure (S201 to S207) is repeated.

When every function of the service API is through with the process of creating the source code of the adaptor 26 (S206), the code creation section 11 selects any one of the functions of the client API not yet through with creation of the source code of the adaptor 26 (S208).

The code creation section 11 then refers to the parameter trees (PTs) to check the type information of the arguments of the function, and based thereon, creates a source code of a dummy function (S209). The dummy function is a function executing no process at all. For any of the functions of the client API including any corresponding function of the service API, to be specific, for any of the functions of the client API having the same semantic information as the function of the service API, the source code of the adaptor 26 has been created by the processes of S202 to S206. Accordingly, the functions of the client API herein include no function of the corresponding service API, and thus the source code for the function of the client API created in S209 will be a dummy function executing no process at all.

After creating the dummy function as above, the code creation section 11 checks every function of the client API being a creation target of the dummy function whether creation of the dummy function (S209) is completed or not (S210), and if it is not yet completed, the procedure (S208 and S209) is repeated until the creation of the dummy function is completed. On the other hand, after completing creation of the dummy function, the code creation section 11 ends this adaptor code creation process (S106 of FIG. 3).

This is the procedure for the adaptor code creation process. With the procedure described above, any function of the client API including no function of any corresponding service API is handled as a dummy function, and is so configured as to create a dummy code of the adaptor 26. When there is such a function of the client API, the procedure may be suspended, and an error notification may be made to the user to make him or her select whether or not to end the process, and whether or not to create a dummy code.

The service-client parameter mapping process in S204 of FIG. 9 is described in detail by referring to FIG. 13. For use to evaluate the degree of match of parameters between the service API and the client API, the code creation section 11 carries therein a matching counter indicating the number of parameter matches, and a no-matching counter indicating the number of parameter no-matches. Prior to starting the process below, the code creation section 11 initializes in advance the matching and no-matching counters to 0.

The code creation section 11 selects one of the nodes including the input/output information from the parameter trees (PTs) of the functions of the service API (S301), and performs mapping in the procedure that will be described below. When every node is through with the process, the procedure goes to S322 (S302).

When the node selected in S301 is of the “arraycount” type, the code creation section 11 does not execute the following processes, and the procedure returns to the process of S301 (S303). This is because the parameters of the “arraycount” type will be collectively subjected to mapping later. Hereinafter, any node of the “arraycount” type is referred to as array-element-number node, and any node whose type is “array” is referred to as array node.

The code creation section 11 refers to the device attribute 13b in the configuration information 13, and acquires the device attribute 13b corresponding to the device ID 22a provided by the controller 20 in S104 (FIG. 3). The code creation section 11 searches the device attribute 13b acquired as such for any attribute parameter having the semantic information same as the node selected in S301 (S304).

In FIG. 7 example, the device attribute 13b includes one attribute parameter of “(semantic information, type, attribute value)=(devAddr, String, 192.168.0.3)”, i.e., information below the element of “device”. In this example, the number of the attribute parameters set to the device attribute 13b is only one, but a plurality of attribute parameters are set thereto in some cases. When the node with the node ID of 001 in the parameter tree (PT3) is selected in S301, the semantic information “devAddr” of this node is the same as the semantic information of the attribute parameter set as such, and thus the search result is the attribute parameter of “(semantic information, type, attribute value)=(devAddr, String, 192.168.0.3)”.

When finding any attribute parameter with a match of the semantic information in S304, the code creation section 11 increments the matching counter (S311), registers the node ID (001 in this example) of the node selected in S301 into the service API parameter of the parameter map table (MT), and then registers “@devAttr” to the fixed variable of the parameter map table (MT) (S312).

When such a predetermined attribute parameter is not found in S304, the code creation section 11 searches the parameter trees (PTs) of the client API for any node having the same semantic information and input/output information as the node selected in S301 (S306).

When the code creation section 11 selects the node with the node ID of 002 in the parameter tree (PT3) in S301, for example, the node with the node ID of 003 will be selected from the parameter tree (PT1). These nodes share the same setting items, i.e., “semantic information, input/output information)=(devCntl/devType, in)”.

When any node having the same semantic information and input/output information is found on the parameter tree of the client API as such in S306, the code creation section 11 increments the matching counter (S311), and registers the node ID of the node selected in S301 to the service API parameter ID of the parameter map table (MT). The code creation section 11 then registers the node ID of the node on the parameter tree PT of the client API acquired in S306 to the client API parameter ID of the parameter map table (MT).

When the search failed to find such a predetermined node in S306, the code creation section 11 refers to the client API definition 22b provided by the controller 20 in S104, and searches the fixed variables found in the client API definition 22b for any fixed variable having the same semantic information as the node selected in S301 (S308).

When the code creation section 11 selects the node with the node ID of 005 in the parameter tree (PT3) in S301, for example, the client API definition 22b is searched for any fixed variable having the semantic information of “devCntl/password”. As a result, the search found a fixed variable having the attribute parameter of “(semantic information, type, variable value)”=(devCntl/password, String, hogehoge)”.

When the search found such a fixed variable having the same semantic information in S308, the code creation section 11 increments the matching counter (S311), and registers the node ID of the node selected in S301 to the service API parameter ID of the parameter map table (MT). The code creation section 11 then registers, in the format of “type: variable value”, the type and value of the fixed variable acquired in S308 to the fixed variable of the parameter map table (MT) (S312). For example, if with “(type, variable value)=“(String, hogehoge)”, registered is “String: hogehoge”.

When the search failed to find such a predetermined node in S308, it means that a parameter corresponding thereto is not also found. The code creation section 11 thus increments the no-matching counter (S310), and the procedure returns to the process of S301.

After the process of S312 is completed, the code creation section 11 examines the nodes starting from the node selected in S301 in the direction toward the root node (params) to check whether there is any array node on the way or not (S313). When such a node is found, the procedure goes to the process of S314, and mapping is performed to the array-element-number node corresponding to the array node. When the code creation section 11 selects the node with the node ID of 002 in the parameter tree (PT3) in S301, for example, the selected node has the type of “short[]”. This represents the array, and thus the procedure goes to the process of S314.

When such an array node is found in S313, the code creation section 11 lists the array node(s) found between the node selected in S301 and the root node, and for each of the array nodes, traces back the relationship of the “array elements” in the parameter tree (PT), thereby creating a list of the array-element-number nodes respectively correlated with the array nodes (S314). The code creation section 11 then makes the order in the list of the array-element-number nodes match the appearance order of the array nodes found between the node selected in S301 and the root node.

Note here that no array will be found in the parameters to be provided to the fixed variable of the device attribute 13b and the client API definition 22b. Accordingly, at the time of execution of this process (S314), the node of the client API is logically found for mapping to the node of the service API in the process of S306 (Y for determination in S307).

The code creation section 11 executes the process similar to the above also to the node acquired in S306, i.e., the node of the client API to be mapped to the node of the service API to find the array nodes between the root node and the above node, and creates a list of the array-element-number nodes to be respectively correlated to the nodes (S314). Also in this process, the code creation section 11 makes the order in the list of the array-element-number nodes match the appearance order of the array nodes found between the node acquired in S306 and the root node.

The code creation section 11 then performs mapping of the array-element-number nodes by establishing a correlation, in the same order as in the lists, among the resulting elements created as such in the lists, i.e., the list of the array-element-number nodes of the service API and the list of the array-element-number nodes of the client API.

When the node with the node ID of 002 is selected in S301 from the parameter tree (PT3), the node showing the type of an array found between the node and the root node is only the above node (node ID=002). The node showing the array-element relationship with the node is the one with the node ID of 004, and thus the list of the array-element-number nodes of the service API will be “[node ID]=[004]”. The node of the client API to be mapped to the node selected in S301 is the node with the node ID of 003 in the parameter tree (PT1). The array node found between the node and the root node is the node with the node ID of 002, and thus the list of the array-element-number nodes of the client API will be “[node ID]=[005]”.

The code creation section 11 then extracts the node IDs, one from the head of the list of the array-element-number nodes of the service API created in S314, and one from the head of the list of the array-element-number nodes of the client API (S315). Herein, the code creation section 11 deletes those extracted node IDs from the lists, respectively.

The code creation section 11 checks whether either of the node IDs extracted in S315 has been already registered in the parameter map table (MT) or not. That is, the code creation section 11 checks whether the service API parameter ID of the parameter map table (MT) already includes the node ID extracted in S315 from the list of the array-element-number nodes of the service API or not, and checks whether the client API parameter ID of the parameter map table (MT) already includes the node ID extracted in S315 from the list of the array-element-number nodes of the client service API or not (S316). When the code creation section 11 confirms at least either of the checks, the procedure goes to S317 for consistency check of the parameter map table (MT). Otherwise the procedure goes to S319 for registration into the parameter map table (MT).

When at least either of the two node IDs extracted in S315 is found in the parameter map table (MT), the code creation section 11 then checks whether these two node IDs are registered in the same entry in the parameter map table (MT) or not (S317). The code creation section 11 then checks whether such requirements are satisfied or not (S318), and when the consistency is confirmed, the procedure goes to the process of S321. In any other states, i.e., such requirements are not satisfied, it means that some consistency contradiction is observed in the parameter map table (MT), and thus the procedure is ended in error.

When the parameter map table (MT) does not include both of the two node IDs extracted in S315, the code creation section 11 increments the matching counter (S319).

The code creation section 11 then creates a new entry in the parameter map table (MT), and registers the node ID extracted in S315 from the list of the array-element-number nodes of the service API as the service API parameter ID of the new entry. The code creation section 11 also registers the node ID extracted in S315 from the list of the array-element-number nodes of the client API as the client API parameter IDs of the new entry (S320).

After completion of the process by the code creation section 11 to every node found in the lists of the array-element-number nodes created in S314, the procedure returns to S301, and otherwise the procedure returns to S315 to repeat the node mapping process (S315 to S320) (S321).

When the mapping process is completed to every node having the input/output information configuring the parameter trees (PTs) of the functions of the service API, the code creation section 11 calculates the matching ratio using the following equation.

Matching Ratio (Matching Counter)/((Matching Counter)+(No-matching Counter))

When the resulting matching ratio is smaller than a predetermined value, it means that the parameter similarity is low between the client API and the service API so that the code creation section 11 ends, in error, the parameter mapping process. When the matching ratio is the predetermined value or larger, the process is ended in a normal manner (S322).

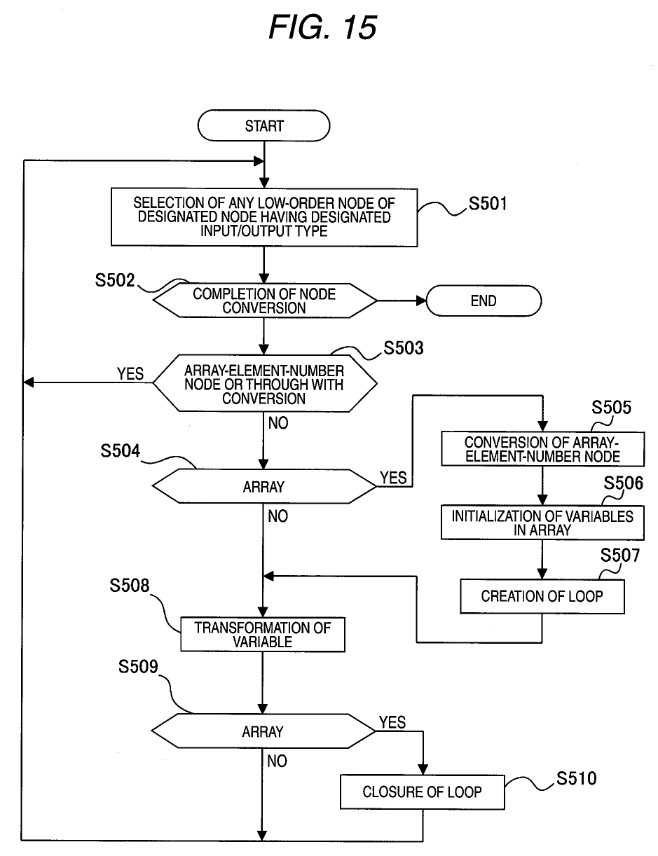

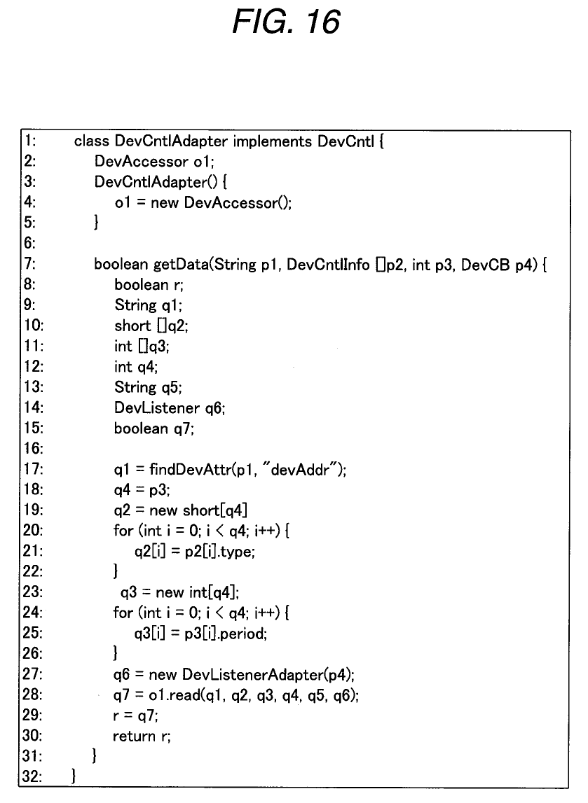

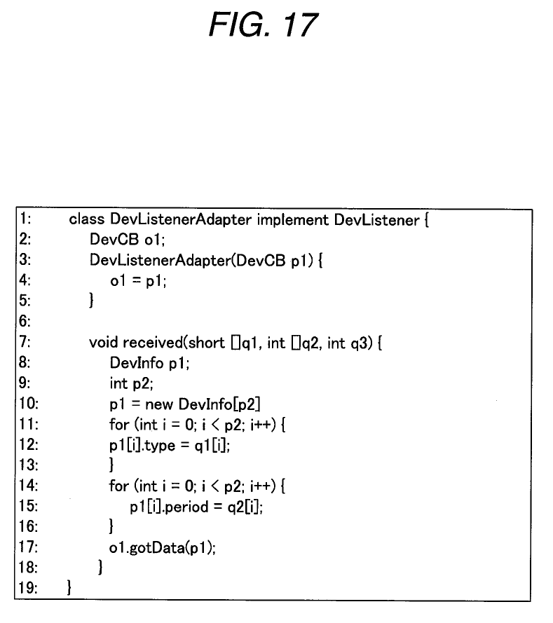

By referring to FIGS. 14 to 17, the code creation process in S206 of FIG. 9 is described in detail. At the time of starting the process of S206, a function pair being a target for adaptor creation is already determined between the service API and the client API (refer to S201 and S202), and the corresponding parameter tree (PT, refer to S203) and the corresponding parameter map table (MT, refer to S204 and S205) are also already created. In this process, such information is used as a basis to create a source code of the adaptor 26. FIGS. 14 and 15 show the flow of this process, and FIGS. 16 and 17 each show an exemplary source code to be created for the adaptor 26.

First of all, the code creation section 11 checks whether the function of the service API selected in S201 is the callback function or not (S401).

When the check result in S401 tells that the function is not the callback function, the source code to be created for the adaptor 26 will have the function of the client API as an external interface, and will call the function of the service API therein. In the below, a specific description is given with an exemplary case where the function being a target for adaptor creation is the “read” function of the service API and the “getData” function of the client API. FIG. 16 shows a source code to be created in this example for the adaptor.

The code creation section 11 creates a source code for initializing the function (S402).

First of all, the code creation section 11 defines, by class, the client API having the “getData” function of the client API as a method using the class name of the client API determined in S202 (FIG. 9). The code creation section 11 also creates a constructor (lines 1 to 6 of FIG. 16). Herein, when the class definition has been already done, and when the constructor has been already created, the code creation section 11 does not have to go through such processes.

The code creation section 11 then determines the type information about the arguments and return values of the function. This determination is made based on the nodes configuring the first hierarchy of the parameter tree (PT1) of the client API. Based on the resulting type information and the function name of the client API determined in S202 (FIG. 9), the code creation section 11 creates a type definition of the function (line 7 of FIG. 16). In FIG. 16 example, the variable name of the n-th argument is pn. The code creation section 11 also creates a source code that declares the return values as a local variable (r) of the function (line 8 of FIG. 16).

The code creation section 11 then determines the type information about the arguments and return values of the service API. This determination is made based on the nodes configuring the first hierarchy of the parameter tree (PT3) of the service API. The code creation section 11 then creates a source code that declares those as a local variable (lines 9 to 15 of FIG. 16). In FIG. 16 example, the variable name of the n-th argument is qn, and the index number of the variable name of the local variable corresponding to the return values is the final number (q7 in the drawing).

The code creation section 11 then creates a source code for acquisition of the device attribute value (S403).

First of all, the code creation section 11 searches the parameter map table (MT1) for any entry having the fixed variable of “@devAttr”. When the search found such an entry, the code creation section 11 then searches the parameter tree (PT3) of the service API for any node whose node ID is the service API parameter ID of the entry, and acquires the semantic information of the node, i.e., semantic information 1. The code creation section 11 also acquires a local variable corresponding to the node, i.e., local variable 1. The code creation section 11 also searches the nodes configuring the parameter tree (PT1) of the client API for any node having the semantic information of “@devID”, and then acquires a local variable corresponding to the node, i.e., local variable 2.

The code creation section 11 then creates a code for calling the internal function of “findDevAttr” of the adaptor automatic creation framework, i.e., a line 17 of FIG. 16. This “findDevAttr” function goes through a process of finding the value parameter of the device attribute of any corresponding device based on the device ID and the semantic information parameter of the device attribute. The first argument of the “findDevAttr” function is the device ID, the second argument thereof is the semantic information parameter of the device attribute, and the return value is the value parameter of the device attribute. As such, the code creation section 11 creates a source code in which the local variable 2 acquired by the search process above is substituted into the first argument of the “findDevAttr” function, and the semantic information 1 is substituted into the second argument thereof, and the return value of the function is substituted into the local variable 1.

After the “findDevAttr” function is called, the program execution section 50 of the controller 20 uses the designated device ID and semantic information to make an inquiry to the management server 10 about the value parameter of the device attribute corresponding thereto. When the management server 10 receives such an inquiry, the configuration management section 12 searches the configuration information 13 using a key of the received device ID, and acquires one or more device attributes 13b corresponding to the device ID. The configuration management section 12 then searches the device attribute 13b using a key of the received semantic information, and acquires the attribute value of the device attribute parameter corresponding to the semantic information. The configuration management section 12 then returns the attributes value back to the controller 20, and the “findDevAttr” function returns the attribute value provided by the management server 10 as a return value.

The “findDevAttr” function is the one provided by the adaptor automatic creation framework described in this example, and is linked to the adaptor 26 dynamically or statically at the time of running of the adaptor 26. As another possible embodiment, the “findDevAttr” function may be distributed to the controller 20 from the management server 10 in S108 (FIG. 3), and may be linked statically to the sensor control module 13d or the adaptor 26, or the “findDevAttr” function may be stored in advance in the controller 20 as a library, and at the time of running of the adaptor 26, may be linked dynamically to the adaptor 26.

With such a configuration that the “findDevAttr” function is called at the time of running of the adaptor 26, and the attribute parameter of the device is checked, even if there is some change to the various settings of the device, e.g., address and port number, there is no need to change the application logic 24.

In FIG. 16 example, the device ID is the argument of the function of the client API, and the value parameter of the device attribute is the argument of the function of the service API. Alternatively, instead of directly substituting the value parameter of the device ID and the device attribute into the arguments of the function, the arguments of the function may be used as the members of the structure to which the value parameter of the device ID and the device attribute is substituted, i.e., API specification.

Still alternatively, the nodes configuring the parameter tree (PT3) of the service API may include a plurality of nodes having the semantic information of “@devAttr”. If this is the case, to each of such nodes having the semantic information of “@devAttr”, the “findDevAttr” function will be executed.

The code creation section 11 then executes the source code creation process for transformation of an input variable (S404).

To be specific, the code creation section 11 creates a source code (lines 18 to 27 of FIG. 16) in which value substitution is taken place to any of the local variables created in S402 as the arguments of the function of the service API not yet through with value substitution in S403. The code creation section 11 designates the root node of the parameter tree (PT3) of the service API as node information, and designates “in” as the input/output information. The code creation section 11 thus calls the sub routine for variable transformation of FIG. 15, thereby implementing this process. The internal process of the sub routine will be described in detail later.

After completing value setting to every argument of the function of the service API in S403 and S404, the code creation section 11 creates a source code for calling the function of the service API (line 28 of FIG. 16) (S405). Once the function of the service API is called, the return value thereof is substituted into the local variable created in S402 as the return value of the function of the service API.

The code creation section 11 then executes a source code creation process for transformation of an output variable (S406). To be specific, the code creation section 11 creates a source code (line 29 of FIG. 16) in which the execution result of the service API is substituted with respect to the variable having the arguments and the return values of the function of the client API. The code creation section 11 designates the root node of the parameter tree (PT1) of the client API as node information, and designates “out” as the input/output information. The code creation section 11 thus calls the sub routine for variable transformation of FIG. 15, thereby implementing this process. The internal process of the sub routine will be described in detail later.

Lastly, the code creation section 11 creates a source code (lines 30 to 31 of FIG. 16) for putting back the return values, and ending the function (S407). As such, the source code is created for the “getData” function of the client API.

On the other hand, when the check result in S401 tells that the function is the callback function, the source code to be created for the adaptor 26 will have the function of the service API as an external interface, and call the function of the client API therein. When the function of the service API is the callback function as such, in the source code created for the adaptor 26, the call relation between the service API and the client API will be reversed as in the normal function. Other than this, the source code creation process for the adaptor 26 is executed similarly to the processes of S402 to S407 described above. In the below, the processes of S408 to S412 will be described mainly with differences from the processes of S402 to S407.

In the below, a specific description is given with an exemplary case where the function of an adaptor creation target is the “received” function of the service API and the “gotData” function of the client API. FIG. 17 shows a source code of the adaptor 26 to be created in this example.

The code creation section 11 creates, in the procedure similar to S402, a class definition of the service API and a constructor, and a source code for initializing the function (S408).

The constructor to be created is assumed as executing a process of internally keeping a callback object of the client API with the callback object being the arguments (lines 3 to 5 of FIG. 17).

Based on the parameter tree (PT4) of the service API, the code creation section 11 also determines the arguments and the return values of the function, and creates a type definition of the function (line 7 of FIG. 17). Based on the parameter tree (PT2) of the client API, the code creation section 11 creates a source code (lines 8 to 9 of FIG. 17) for declaring the arguments and the return values of the “gotData” function of the client API as a local variable.

The code creation section 11 then goes through the source code creation process for transformation of an input variable (S409). To be specific, the code creation section 11 creates a source code (lines 10 to 16 of FIG. 17) in which a value is substituted into the local variable created in S408 as the arguments of the “gotData” function of the client API. This process is executed similarly to the process S404 except that the client API and the service API are reversed in terms of role.

The code creation section 11 then creates a source code (line 17 of FIG. 17) for calling the function of the client API (S410). The return values of the function are substituted into the local variable created in S408 as the return values of the function of the client API. Herein, when the function of the client API is of a type putting back no return value as the “gotData” function of the client API, there is no need to create a source code for use to execute such a return value substitution process.

The code creation section 11 then executes the source code creation process for transformation of an output variable (S411). To be specific, the code creation section 11 creates a source code for substituting the execution result of the client API to a variable having the arguments and the return values of the function of the service API. This process is executed similarly to the process of S404 except that the client API and the service API are reversed in terms of role. Note here that because the parameter tree (PT4) of the service API has no node whose input/output type is “out”, and thus a source code corresponding to such a node is not created in FIG. 17 example.

Lastly, the code creation section 11 creates a source code (line 18 of FIG. 17) for putting back the return value, and ending the function (S412). As such, the source code of the “received” function of the service API is completed.

Described next is the detailed process procedure of the variable transformation sub routine to be executed in S404, S406, S409, and S411 of FIG. 14 by referring to FIG. 15. Herein, the process details are similar in these steps (S404, S406, S409, and S411), and thus exemplified below is a case where the “getData” function of the client API is created in S404.

In S404, the code creation section 11 designates a root node of the parameter tree (PT3) of the service API as the root node information, and designates “in” as the input/output information, thereby calling the variable transformation sub routine of FIG. 15.

First of all, the code creation section 11 lists any of the low-order nodes in the designated root node having the input/output information of “in”, and selects one therefrom (S501). In this example, the nodes of “node ID={001, 002, 003, 004, 005, and 006} are selected from the parameter tree (PT3).

The code creation section 11 creates a source code for value substitution to the variable corresponding to the nodes selected in S501 in the following procedure. After every node is through with the process, this is the end of the process (S502).

The code creation section 11 checks the type of the nodes selected in S501, and when the type is “arraycount”, the procedure skips the processes thereafter, and returns to the process of S501. The procedure also skips the processes thereafter, and returns to the process of S501 when the parameters corresponding to the nodes are already through with the value substitution process. To be specific, because the value substitution to the parameters corresponding to the device attribute is through in S403, and thus the code creation section 11 does not create any source code defining the value substitution process to the parameters corresponding to the device attribute (S503).

In the following description, the node with the node ID of 002 is assumed as being selected from the parameter tree (PT3) in S501. The nodes selected in S501 are checked toward the root node to see whether there is any array node on the way. When there is any array node on the way, the array node is subjected to a loop process in S505 to S507, and otherwise, the procedure goes to S508 for the value substitution process to the parameters (S504).

The code creation section 11 checks the nodes selected in S501 toward the root node, and lists any array nodes found on the way. The code creation section 11 then picks up the array element-number-node corresponding to the array node(s), and creates a source code for the value substitution process to the parameter corresponding to the array-element-number node in the following procedure.

The code creation section 11 determines, using the parameter map table (MT), which of the parameters to use as a substitute source for the parameter picked up as above. The method of accessing the parameters is determined based on the parameter tree (PT) of the service API, and that of the client API. The correlation between the parameter tree (PT) and the variables on the source code is determined using the fact that the n-th argument name of the client API is pn, and the n-th argument name of the service API is qn. Based on such information, the code creation section 11 creates a source code for the value substitution process to the parameter corresponding to the array-element-number node.

When the node with the node ID of 002 is selected from the parameter tree (PT3) in S501, the array node found on the way is only the node with the node ID of 002, and the array-element-number node corresponding thereto is the node with the node ID of 004. Referring to the parameter map table (MT1) tells that the client API parameter ID corresponding to the entry with the ID of the service API parameter is 004 is 005. Accordingly, the code creation section 11 creates, from the parameter in which the node ID of the parameter tree (PT1) of the client API is 005, a source code for value substitution to the parameter in which the node ID of the parameter tree (PT3) of the service API is 004. In this example, the code creation section 11 creates the source code in the line 18 of FIG. 16 (S505).

The code creation section 11 then initializes the array nodes of the service API listed in S505. In this example, created is a source code (line 19 of FIG. 16) for use to initialize the array parameter corresponding to the node with the node ID of 002 in the parameter tree (PT3) of the service API (S506).

The code creation section 11 then creates a loop for an index variable for accessing the array parameter. In the resulting loop, a source code is created for accessing the parameter selected in S501, but this time, it is important to note that the code creation section 11 never fails to use the index variable to access the array parameter (507).

The code creation section 11 goes through a process of creating a source code for variable transformation, i.e., a source code for the value substitution process to the parameter selected in S501 (S508). Also in this process, similarly to S505, using the parameter map table (MT), the parameter of the client API (or the parameter of the service API) is acquired for mapping to the parameter selected in S501. The method of accessing the variables from the parameter tree (PT) of the service API and that of the client API is then determined, thereby creating the corresponding source code.

In this example, because the node with the node ID of 002 is selected in S501 from the parameter tree (PT3) of the service API, referring to the parameter map table (MT1) tells that the parameter of the corresponding client API is the one related to the node with the node ID of 003. As such, created is the source code for value substitution between these parameters. As a result, the source code in a line 21 of FIG. 16 is created (S508 until this process).

When creating the loop for accessing the array node in S505 to S507 (when determination in S509 is Y), the code creation section 11 creates a source code for the process of closing the loop (line 22 of FIG. 16) (S510).

As such, described is the specific example when the node with the node ID of 002 is selected from the parameter tree (PT3) in S501. Such a source code creation process is executed similarly also to a case where the node with another node ID is selected in S501 (lines 23 to 27 of FIG. 16).

The first example is described as such, but embodiments of the invention are surely not restrictive thereto. In the below, a second example is described as another embodiment of the invention.

### SECOND EXAMPLE

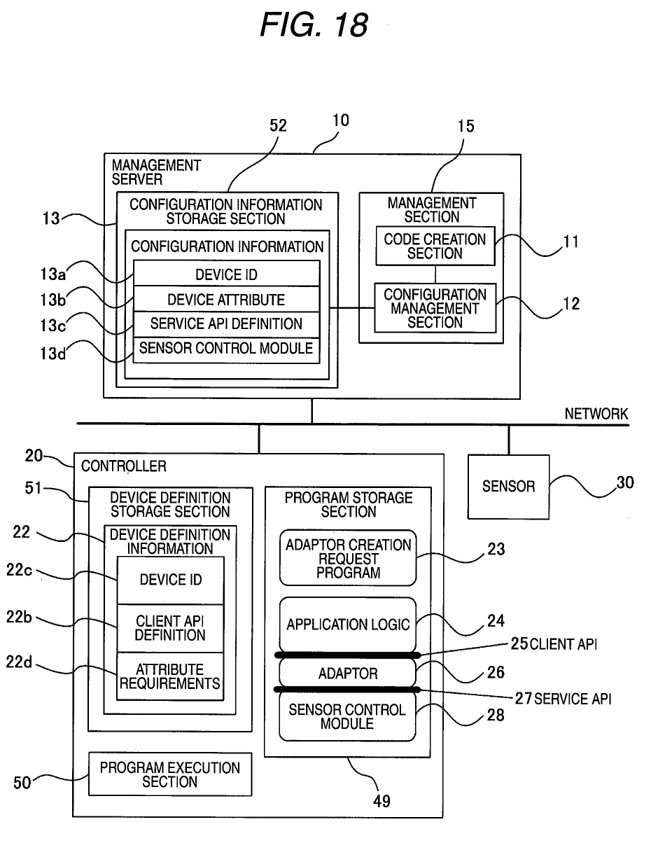

In a second example, described is a case where, in a system (FIG. 18) to which the embodiments of the invention are applied for monitoring the temperature and humidity in each room of a building, the sensors 30 are not each designated by an identifier thereof but an attribute thereof. In such a system monitoring the temperature and humidity of each room in the building, for example, required are the capabilities to determine which of the sensors to drive based on the attribute of the sensors 30, e.g., position information including floor name and room number, and measurement items including temperature and humidity.

In consideration thereof, the second example provides the framework for designating which sensor 30 to drive by providing the client API 25 with the attribute information about the sensors 30. In this system, the client API 25 may be provided with the attribute information including the position information and the measurement items as above for designation of which sensor 30 to drive. Note that, because the second example is quite alike the first example, differences therebetween are to be mainly described below.

FIG. 18 shows the system configuration in this example. Compared with the first example, in this second example, some changes are made to the device definition information 22 in the device definition storage section 51. That is, the device ID 22a in the first example is replaced with an attribute ID 22c, and attribute requirements 22d are newly provided.

The attribute requirements 22d include the attribute of the senor 30 to be used by the program execution section 50, and the attribute ID 22c includes the identifier of each of the attribute requirements 22d. The attribute ID 22c is used as the argument of the client API 25. The attribute ID 22c is an identifier for use to uniquely identify the attribute requirements 22d found in the device definition information 22. There is thus not need for the attribute ID 22c to match the attribute ID found in the device definition information of any other application on the system, and may be unified in the controller 20.

Moreover, there may be a case where a large number of items are used as the attribute requirements 22d, and thus when such attribute requirements 22d are directly provided as the arguments of the client API 25, there may cause a possible size increase of the source code of the application logic 24. In consideration thereof, as described in the foregoing, the attribute ID 22c may be defined in advance as an identifier for use to identify the attribute requirements 22d, and such an attribute ID 22c may be designated from the application logic 24. As such, the client API 25 is provided with the attribute ID 22c, and this is essentially the same as the manner of directly providing the attribute requirements 22d to the client API 25. Herein, when the attribute requirements 22d vary less, the attribute requirements 22d may be directly provided to the client API.

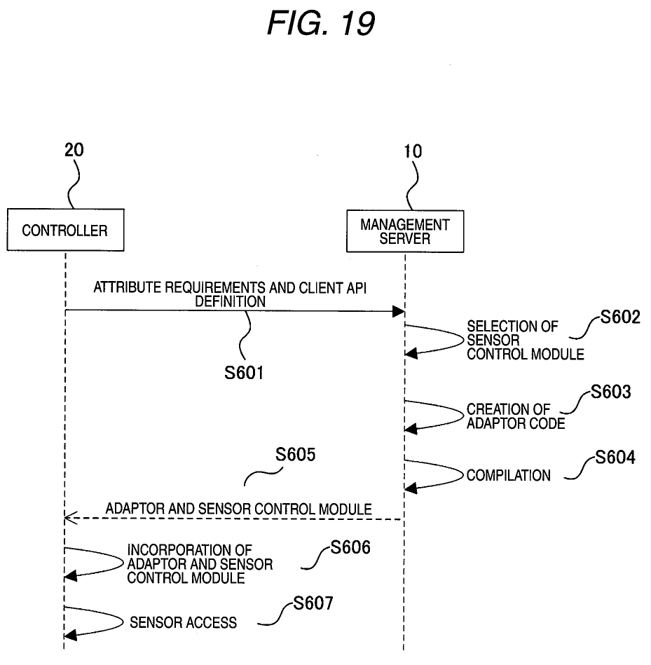

FIG. 19 shows the procedure for the program execution section 50 of the controller 20 to acquire the adaptor 26 from the management server 10 for incorporation into the program storage section 49, and link together the application logic 24 and the sensor control module 28.

First of all, when the CPU of the controller 20 runs the adaptor creation request program 23 at a predetermined timing, i.e., timing when the CPU runs the application logic 24, the program execution section 50 of the controller 20 acquires the attribute requirements 22d and the client API definition 22b from the device definition information 22 in the device definition storage section 51. The acquisition results are forwarded to the management server 10. In the first example, the program execution section 50 of the controller 20 transmits the device ID 22a and the client API definition 22b (FIG. 3, S104), and in this procedure, the device ID 22a is replaced with the attribute requirements 22d (S601).

The management server 10 searches the configuration information 13 for one or more device attributes 13b matching the received attribute requirements 22d, and then selects any of the sensor control modules 13d corresponding to the device attribute 13b showing the highest matching ratio as the service module for use by the program execution section 50 for sensor control, i.e., as the target module to associate with the application logic 24 for control over the sensor 30. Herein, when the search failed to find the device attribute 13b showing the matching ratio of a predetermined reference value or higher, it means that there is no information about the sensor 30 to be used by the program execution section 50, and thus the code creation section 11 of the management server 10 may end the process in error (S602).

The procedure for the following processes (S603 to S607) is the same as the procedure described in the first example (S106 to S110 of FIG. 3), and thus is not described again. In this example, similarly to the first example, a “bootstrap adaptor” may be incorporated in advance in the program to be executed, i.e., the adaptor creation request program 23, thereby being able to download, by on-demand, the adaptor 26 from the management server when the sensor is put in use.

The source code of the adaptor 26 to be created by the code creation section 11 is almost the same as that described in the first example, but the procedure for processing the “findDevAttr” function provided by the adaptor automatic creation framework is partially different from the first example. That is, in the second example, the first argument of the “findDevAttr” function to be designated is not the device ID but the attribute ID 22c. The “findDevAttr” function searches the device definition information 22 using a key of the attribute ID 22c designated as the first argument, and acquires the corresponding attribute requirements 22d. The “findDevAttr” function then acquires the device attribute 13b of the sensor matching the attribute requirements 22d from the configuration information 13 of the management server 10.

The attribute requirements 22d can vary to include the position information, the sensor type, and others. Moreover, the attribute requirements 22d can be flexibly set, e.g., combination of item name and value. For example, the item and the value may have a one-to-one relationship such as “position information=conference room #1”, or “sensor type=humidity sensor”, or one item may be designated by a limited value range or by a limited pattern of value, e.g., “position information =every room on the first floor”, “position information=192.168.03. to 192.168.0.167”, or “sensor type=sensor with a serial number started with “B” or “C””.

The second example is described as such, and described next is a third example as still another embodiment.

### THIRD EXAMPLE

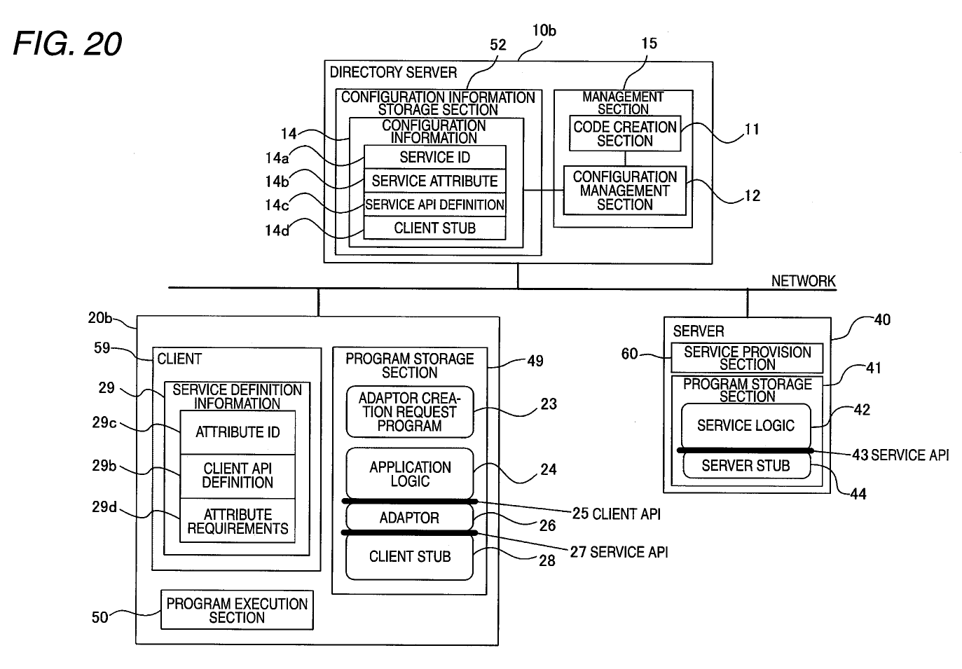

In a third example, exemplified is a case where the embodiments of the invention are applied to an information system constructed by SOA (Service Oriented Architecture). FIG. 20 shows the system configuration in this example. In the information system of this example, the controller 20 in the system of the second example is replaced with a client 20b, the sensor 30 is replaced with a server 40, and the management server 10 is replaced with a directory server 10b. Moreover, the device definition storage section 51 in the second example is replaced with a service definition storage section 59, and the device definition information 22 is replaced with service definition information 29. Herein, similarly to the first and second examples, such components, i.e., the directory server 10b, the client 20b, and server 40, can be the computer 100 of a general configuration as shown in FIG. 2.

In this example, the application logic 24 in the program storage section 49 corresponds to the client module, and a service logic 42 operating on the server 40 corresponds to the service module. In this information system, as software for communications between the application logic 24 and the service logic 42, a client stub 28 is incorporated (linked) in the program storage section 49 on the side of the client 20b, and a server stub 44 is incorporated in the program storage section 41 on the side of the server 40. The service logic 42 and the server stub 44 stored in the program storage section 41 of the server 40 are to be implemented in capability terms by a service provision section 60. Herein, the service provision section 60 is to be implemented in capability terms by a CPU of the server 40 running the service logic 42 and the server stub 44.

When the CPU 101 of the client 20b runs the client stub 28, the program execution section 50 converts the parameters forwarded to the function of the service API 27 into a message in the format available for transmission/reception on the network, and the conversion result is forwarded to the server 40. When the server 40 receives the message from the client stub 28, the service provision section 60 calls the service API 43 provided by the service logic 42. The client stub 28 in the client 20b provides, as an external interface, the service API 27 same as the service API 43 provided by the service logic 42 in the server 40 so that the program execution section 50 can handle the client stub 28 as the service logic 42.

In this example, the sensor 30 in the second example (FIG. 18) is replaced with the server 40, and thus the information to be stored in the configuration information 13 on the directory server 10b is different from that in the second example. To be specific, the device ID 13a is replaced with a service ID 14a, the device attribute 13b is replaced with a service attribute 14b, and the sensor control module 13d is replaced with a client stub 14d. In the service definition storage section 59 on the client 20b, the device definition information 22 used in the second example is replaced with the service definition information 29. However, the roles of these replaced components are similarly to those in the second example.

That is, when the attribute requirements 29d in the service definition information 29 include the attribute of any service a user wants to use, e.g., service provided by the service program 41, the program execution section 50 of the client 20b selects the application logic 24 at a predetermined timing, and to the directory server 10b, forwards the client API definition 29b corresponding to the attribute requirements 29d and the selected application logic 24. The directory server 10b then automatically creates the adaptor 26 based on the provided attribute requirements 29d, i.e., based on the service API definition 14c of the optimum service, i.e., service provided by the service program 41 in this example, and the client API definition 29b selected by the program execution section 50. The procedure for creation and incorporation of the adaptor 26 is similar to that described in the first and second examples, and thus is not described in detail again.

As such, the examples of the embodiments are described, but the invention is surely not restrictive to those three embodiments, and numerous other modifications and variations can be devised without departing from the scope of the invention.

For example, the code creation section 11 is not necessarily configured on the management server 10 or on the directory server 10b, and in the first and second examples, may be configured on the controller 20. In the third example, the code creation section 11 may be configured on the client 20b or on the server 40.

In the first example, at the time of creating the adaptor 26, the code creation section 11 performs parameter mapping of the APIs based on the semantic information indicating the use and details of the parameters found in the service API definition 13c and the client API definition 22b (S204 and S205 of FIG. 9, more in detail, S304, S306, and S308 of FIG. 13). Also in the system in which the service API definition 13c and the client API definition 22b do not include such semantic information, parameter mapping can be performed. In this case, the code creation section 11 can perform parameter mapping based on the type information about the parameters. As still another example, the code creation section 11 can perform parameter mapping based on the combination of two types of semantic information, i.e., information indicating the use and details of the parameters, and type information about the parameters.

Moreover, in the embodiments of the invention, application to any specific programming language is not assumed, and application to any arbitrary programming language is possible. For Example, the code creation section 11 creates a source code of the adaptor 26, and the programming language of the source code may not be restrictive to that for use to develop the application logic 24 (FIGS. 1 and 18), the sensor control module 13d (FIGS. 1 and 18), and the client stub 28 (FIG. 20).

Moreover, the sensor control module 13d (FIGS. 1 and 18) and the client stub 28 (FIG. 20) are not necessarily stored in the management server 10 and the directory server 10b in the binary form to be applicable on a computer, and may be in the state of a source code partially or entirely. If this is the case, the code creation section 11 may compile the source code, and the sensor control module 28 executable on the controller 20 may be created thereby, or the source code may be compiled on the controller 20 (FIGS. 1 and 18) or on the client 20b (FIG. 20), and the executable client stub 28 may be created thereby. Moreover, such compilation of the source code may be performed by the program execution section 50 provided with the source code from the code creation section 11.

In the examples above, in the adaptor code creation process (S106 of FIG. 3), the functions of the service API function are firstly selected (S201 of FIG. 9) and the functions of the client API corresponding thereto are then determined for establishing a correlation therebetween. For establishing a correlation between the parameters, the parameters of the service API function are firstly selected (S301 of FIG. 13), and the parameters of the client API function corresponding thereof are then determined. Alternatively, the selection order may be reversed to the functions and the parameters.

That is, with an example of the configuration of the first example, for establishing a correlation between the functions, in the step of creating the adaptor (S106 of FIG. 3), the code creation section executes,

when either a term of client or a term of service is referred to as “first”, and a remaining is referred to as “second”,

a step of selecting a first API function for use by an API of a first module selected by the program execution section 50 or the configuration management section 12,

a step of acquiring first API function semantic information corresponding to the selected first API function, determining second API function semantic information matching the acquired first API function semantic information, and selecting a second API function corresponding to the determined second API function semantic information for use by a second module as a target to associate with the selected first API function, and

a step of creating, based on the first API function and the second API function respectively selected by the program execution section 50 and the configuration management section 12, a part of the adaptor for use as an intermediary between the selected first API function and the selected second API function.

In the above process, when the term of “first” denotes the term of service, and when the term of “second” denotes the term of client, in the adaptor code creation process (S106 of FIG. 3), for establishing a correlation between the functions, the functions of the client API are selected first, and then the functions of the service API corresponding thereto are then determined.

For establishing such a correlation between the functions, in the step of creating the adaptor (S106 of FIG. 3), the code creation section 11 executes,

a step of selecting any of the parameters of the first API function selected by the program execution section 50 or the configuration management section 12,

a step of acquiring first API function parameter semantic information about the selected parameter of the first API function, determining second API function parameter semantic information matching the acquired first API function parameter semantic information, and selecting, as a target to associate with the parameter of the selected first API function, any parameter of a second API function that is corresponding to the determined second API function parameter semantic information and is selected by the configuration management section 12 or the program execution section 50, and

a step of creating, based on the selected parameter of the first API function and the selected parameter of the second API function, a part of the adaptor for use as an intermediary between the first API function and the second API function that have been already selected.

In the above process, when the term of “first” denotes the term of service, and when the term of “second” denotes the term of client, for establishing a correlation between the parameters, the parameters of the client API are selected first, and then the parameters of the service API function corresponding thereto are then determined.

Moreover, in the examples above, as an exemplary external unit, described is the program unit operating in a sensor or in a computer on the network. The sensor is surely not restrictive, and any arbitrary electronic device having capabilities of transmitting data in response to a request from any other devices, e.g., controller 20, will also do.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications within the ambit of the appended claims.

What is claimed is:

1. A module-to-module association support method that supports, as an intermediary, a relation between a service module providing its own capabilities to other modules, and a client module using the capabilities of the service module, the method comprising:
a service API (Application Program Interface) definition step of storing, with a correlation, service API definition information with which a specification of an API of the service module is defined, and semantic information about the service module;
a client API definition step of storing, with a correlation, client API definition information with which a specification of an API of the client module is defined, and semantic information about the client module;
a step of selecting any of the client module and others;
a step of acquiring client module semantic information about the selected client module, determining service module semantic information matching the acquired client module semantic information, and selecting the service module corresponding to the determined service module semantic information as a target to associate with the selected client module; and
a step of creating, based on the client API definition information about the selected client module and the service API definition information about the selected service module, an adaptor for use as an intermediary between the selected client module and the selected service module.

2. The module-to-module association support method according to claim 1, wherein
the service API definition step includes a step of storing, with a correlation, as the service API definition information, a service API function for use by the API of the service module and semantic information about the service API function,
the client API definition step includes a step of storing, with a correlation, as the client API definition information, a client API function for use by the API of the client module and semantic information about the client API function, and
the step of creating the adaptor includes:
when either a term of client or a term of service is referred to as “first”, and a remaining is referred to as “second”,
a step of selecting the first API function for use by the API of the selected first module;
a step of acquiring first API function semantic information about the selected first API function, determining second API function semantic information matching the acquired first API function semantic information, and selecting the second API function corresponding to the determined second API function semantic information for use by the selected second module as a target to associate with the selected first API function; and
a step of creating, based on the selected first API function and the selected second API function, a part of the adaptor for use as the intermediary between the selected first API function and the selected second API function.

3. The module-to-module association support method according to claim 2, wherein
the service API definition step includes a step of storing, with a correlation, as the service API definition information, parameters of the service API function for use by the API of the service module and semantic information about the parameters,
the client API definition step includes a step of storing, with a correlation, as the client API definition information, parameters of the client API function for use by the API of the client module and semantic information about the parameters, and
the step of creating the part of the adaptor includes:
a step of selecting any of the parameters of the selected first API function;
a step of acquiring first API function parameter semantic information about the selected parameter of the first API function, determining second API function parameter semantic information matching the acquired first API function parameter semantic information, and selecting the parameter of the selected second API function corresponding to the determined second API function parameter semantic information as a target to associate with the selected parameter of the first API function; and
a step of creating, with a correlation between the selected parameter of the first API function and the selected parameter of the second API function, the part of the adaptor for use as the intermediary between the selected first API function and the selected second API function.

4. The module-to-module association support method according to claim 3,
wherein the client API definition step includes a step of storing, with a correlation, as the client API definition information, fixed values and semantic information about the fixed values, and the step of creating the part of the adaptor includes:
a step of selecting any of the parameters of the selected first API function;
a step of acquiring first API function parameter semantic information about the selected parameter of the first API function, and when the selected second API function is the client API function, determining second API function fixed value semantic information matching the acquired first API function parameter semantic information, selecting the fixed value of the selected second API function corresponding to the determined second API function fixed value semantic information as a target to associate with the selected parameter of the service API function; and
a step of substituting the selected fixed value into the specified parameter of the service API function, and creating the part of the adaptor for use as the intermediary between the selected client API function and the selected service API function.

5. The module-to-module association support method according to claim 1, further comprising
a step of linking the created adaptor to the selected client module.

6. The module-to-module association support method according to claim 1, wherein
the service module serves to perform data acquisition utilizing an external unit, and
the external unit includes a program unit operating in an electronic device such as sensor or in a computer on a network.

7. The module-to-module association support method according to claim 6, wherein
in the step of creating the adaptor, the adaptor is created in such a manner as to acquire information for use to access the external unit at the time of running of the adaptor.

8. A module-to-module association support program for implementation of the method of claim 1 in a computer.

9. A module-to-module association support system that supports, as an intermediary, a relation between a service module providing its own capabilities to other modules, and a client module using the capabilities of the service module, the system comprising:
a service API definition storage section that stores, with a correlation, service API definition information with which a specification of an API of the service module is defined, and semantic information about the service module;
a client API definition storage section that stores, with a correlation, client API definition information with which a specification of an API of the client module is defined, and semantic information about the client module;
an adaptor creation request section that makes a selection from the client module and others;
an association target selection section that acquires client module semantic information about the selected client module, determines service module semantic information matching the acquired client module semantic information, and selects the service module corresponding to the determined service module semantic information as a target to associate with the selected client module; and
an adaptor creation section that creates, based on the client API definition information about the selected client module and the service API definition information about the selected service module, an adaptor for use as an intermediary between the selected client module and the selected service module.

10. The module-to-module association support system according to claim 9, wherein
the service API definition storage section stores, with a correlation, as the service API definition information, a service API function for use by the API of the service module and semantic information about the service API function, and
the client API definition storage section stores, with a correlation, as the client API definition information, a client API function for use by the API of the client module and semantic information about the client API function, and
the adaptor creation section
when either a term of client or a term of service is referred to as “first”, and a remaining is referred to as “second”,
selects the first API function for use by the API of the selected first module, acquires first API function semantic information corresponding to the selected first API function, determines second API function semantic information matching the acquired first API function semantic information, selects the second API function corresponding to the determined second API function semantic information for use by the selected second module as a target to associate with the selected first API function, and creates, based on the selected first API function and the selected second API function, a part of the adaptor for use as the intermediary between the selected first API function and the selected second API function.

11. The module-to-module association support system according to claim 10, wherein
the service API definition storage section stores, with a correlation, as the service API definition information, parameters of the service API function for use by the API of the service module and semantic information about the parameters,
the client API definition storage section stores, with a correlation, as the client API definition information, parameters of the client API function for use by the API of the client module and semantic information about the parameters, and
the adaptor creation section
selects any of the parameters of the selected first API function,
acquires first API function parameter semantic information about the selected parameter of the first API function, determines second API function parameter semantic information matching the acquired first API function parameter semantic information, and selects the parameter of the selected second API function corresponding to the determined second API function parameter semantic information as a target to associate with the selected parameter of the first API function, and
creates, with a correlation between the selected parameter of the first API function and the selected parameter of the second API function, the part of the adaptor for use as the intermediary between the selected first API function and the selected second API function.

12. The module-to-module association support system according to claim 11, wherein
the client API definition storage section stores, with a correlation, as the client API definition information, fixed values and semantic information about the fixed values, and
the adaptor creation section
identifies, when the selected first API function is the service API function, any of the parameters of the service API function whose semantic in formation is fixed value semantic information,
selects the fixed value corresponding to the semantic information matching the fixed value semantic information of the identified parameter of the service API function as a target to associate with the identified parameter of the service API function, and
correlates the selected parameter of the client API function and the selected parameter of the service API function, substitutes the selected fixed value into the specified parameter of the service API function, and creates the part of the adaptor for use as the intermediary between the selected client API function and the selected service API function.

13. The module-to-module association support system according to claim 9, wherein
the adaptor creation request section links the created adaptor to the selected client module.

14. The module-to-module association support system according to claim 9, wherein
the service module serves to perform data acquisition utilizing an external unit, and
the external unit includes a program unit operating in an electronic device such as sensor or in a computer on a network.

15. The module-to-module association support system according to claim 14, wherein
the adaptor creation section creates the adaptor in such a manner as to acquire information for use to access the external unit at the time of running of the adaptor.
